(19) United States
(12) Patent Application Publication
(10) Pub. No.: US 2025/0305272 A1
(43) Pub. Date: Oct. 2, 2025

(54) MODULAR HOUSING CONSTRUCTION CONNECTOR SYSTEMS

(71) Applicant: Resortments, LLC, Dallas, TX (US)

(72) Inventors: Russell Huckaby, Bryant, AR (US); Zac Mowery, Bryant, AR (US); Tracy Spellmeyer, Bryant, AR (US); Stepan Teryzan, Bryant, AR (US)

(73) Assignee: Resortments, LLC, Dallas, TX (US)

(21) Appl. No.: 19/093,891

(22) Filed: Mar. 28, 2025

Related U.S. Application Data
(60) Provisional application No. 63/573,091, filed on Apr. 2, 2024.

(51) Int. Cl. E04B 1/35; B29C 45/00; B29C 45/17; B29L 31/00; E04B 1/348

(52) U.S. Cl. CPC E04B 1/3505; B29C 45/0005; B29C 45/006; B29C 45/1756; E04B 1/34807; B29L 2031/776

(57) ABSTRACT

A modular construction housing system includes fiber-reinforced wall panels, such as fiberglass wall panels, attached to a roof component via one or more pins extending downwardly from the roof component into an internal cavity of the wall panels. The wall panels and the flooring of the modular construction housing system are integrally formed via molding to reduce the number of separate components and the amount of construction and connection required on-site. The wall panels include a plurality of internal conduits extending through the internal cavity of the wall panels configured to align with internal conduits extending downward from the roof component to allow for electrical wiring and other function to seamlessly extend from the wall to the roof.

### CROSS REFERENCE TO RELATED APPLICATIONS

This application is related to and claims priority from the following U.S. patent application. This application claims priority to and the benefit of U.S. Provisional Patent Application No. 63/573,091, filed Apr. 2, 2024, which is incorporated herein by reference in its entirety.

### BACKGROUND OF THE INVENTION

### 1. Field of the Invention

The present invention relates to modular building construction connectors, and more specifically to connectors for modular housing utilizing fiberglass or other fiber-reinforced materials.

### 2. Description of the Prior Art

It is generally known in the prior art to provide modular housing panels.

Prior art patent documents include the following:

U.S. Pat. No. 4,841,897 for Mobile habitable container by inventor Claflin, filed Jan. 4, 1988 and issued Jun. 27, 1989, discloses a mobile habitable container suitable for use as a houseboat or highway trailer with a land use only mode. The mobile habitable container can be moved over Class I, Class II or Class III highways without oversize permit when mobile and can be rotated 90° to provide the largest practical living space within legal highway limits.

U.S. Pat. No. 7,000,978 for Thin-skin ultralight recreational vehicle body system by inventor Messano, filed Aug. 20, 2004 and issued Feb. 21, 2006, discloses an extremely light weight one-piece “thin-skin” molded RV body that can be manufactured without a heavy steel chassis frame, and which construction method minimizes costly hand labor while lending itself to automated assembly line manufacturing processes as used in the automotive and sport boat industries. Aspects include a variable-height suspension system to decrease frontal area when towed, and which raises the body for use of slideouts; a streamlined storage nose cap that reduces air turbulence to increase fuel economy of the tow vehicle; pivoting road wheels to eliminate tire scrub on multiple axles; steerable wheels for backing in restricted areas; adjustable tongue weight sliding suspension; and a pivoting nose wheel to minimize tongue weight on the tow vehicle.

U.S. Pat. No. 7,908,682 for Fiberglass swimming pool shell having pre-formed sockets to attach miscellaneous items by inventor Sullivan, filed Jan. 4, 2006 and issued Mar. 22, 2011, discloses a pool shell molding system that enables accessories such as tables, chairs, parasols, basketball rims, and volleyball nets to be selectively and easily attached and removed. The pre-formed mold includes a recessed section with an outer edge that contacts and grips the various pool accessories. The depth of the recess is reduced by including a lip section extending from the bottom of the pool accessory, forming a contact and seal with the pool shell. Additionally, the pre-formed mold also includes an extended section with an outer edge that contacts and is gripped by the various pool accessories. The pre-formed mold can also secure a pole structure that includes a pole and a base member attached to the pole that facilitates a flexing locking relationship with the pool surface.

U.S. Pat. No. 4,142,337 for Hydrotherapy spa and method of fabricating same by inventor Holcomb, filed May 31, 1977 and issued Mar. 6, 1979, discloses resin being sprayed onto the inside of a mold. Fiberglass is then applied to the resin to form a shell having a bottom, side walls and an upper, outwardly turned lip. The fiberglass forms a somewhat roughened surface on the inner side of the completed shell, thereby eliminating the cracking and chipping of the inner surface which has heretofore occurred when the fiberglass was on the outer side of the shell and the inner surface of the shell was smooth resin. After the required plumbing is mounted on the shell, the shell can be installed at the desired location, usually in the ground and frequently near a swimming pool. A hole is formed in the ground somewhat larger than the shell and at least three stakes of appropriate length are driven into the bottom of the hole, adjacent the periphery thereof, to a depth such that the upper ends of the stakes coincide with the desired height of the lip of the shell. The shell is then lowered into the hole so that the lip rests on the stakes for support of the shell. At this juncture the hole around the shell is filled with concrete grout which ultimately hardens in order rigidly to set the resulting spa into the ground but which initially is in a semi-liquid state. During the time the grout is semi-liquid it exerts an upward buoyant force on the bottom of the shell, thereby urging the shell upwardly. Pursuant to the method of the present invention the shell is filled with water as the grout is added at a rate such that the weight of the water slightly exceeds the upward force of the grout, thereby maintaining the shell in supporting engagement with the stakes and thus establishing accurate grade and avoiding tilt. Anchors may also be provided on the bottom of the shell, in which case a hardening accelerator, such as calcium chloride, is added to the initial charges of grout until the level of the grout is above the anchors. The accelerator causes the grout to harden and grip the anchors, thus securing the shell in place quickly.

U.S. Pat. No. 10,472,839 for Beach entry fiberglass pool system by inventors Khamis et al., filed May 4, 2018 and issued Nov. 12, 2019, discloses a fiberglass swimming pool system, including a fiberglass swimming pool body defining an interior volume for holding water and positioned in an excavation, a fiberglass flange operationally connected to the fiberglass swimming pool body, a fiberglass lip extending from the flange away from the fiberglass swimming pool body, a truncated fiberglass top wall extending perpendicularly from the flange, a fiberglass ramp extending from the elongated fiberglass riser wall into the interior volume, and a deck extending over the lip and operationally connected to the fiberglass ramp at the top wall. The fiberglass ramp has an angle of decline of between one and fifteen degrees.

### SUMMARY OF THE INVENTION

The present invention relates to modular building construction connectors, and more specifically to connectors for modular housing utilizing fiberglass or other fiber-reinforced materials.

It is an object of this invention to provide novel fiberglass wall components and connections systems and methods for those wall components, allowing for more easily shipped and construction modular housing with improved insulation and durability relative to existing prefabricated construction components.

In one embodiment, the present invention is directed to a system for constructing modular housing, including an outer molding panel, an inner molding panel, a cavity panel, wherein the cavity panel is placed between the outer molding panel and the inner molding panel with an inner gap defined between the cavity panel and the inner molding panel and an outer gap defined between the cavity panel and the outer molding panel, a top plate, configured to sealingly enclose the outer molding panel, the inner molding panel, and the cavity panel, one or more injection molding nozzles configured to inject resin into the inner gap and the outer gap to form an inner layer and an outer layer of a housing wall, one or more lifting devices configured to remove the top plate and the cavity panel, one or more insulation nozzles configured to release insulation material between the inner layer and the outer layer of the housing wall to form an inner insulation layer, and a roof component including wall extensions extending downwardly, wherein the wall extensions are configured to align with the housing wall, wherein the wall extensions of the roof component include a plurality of elongate extruded members extending downwardly, configured to insert into the inner insulation layer of the housing wall.

In another embodiment, the present invention is directed to a method for constructing modular housing, including placing an outer molding panel, an inner molding panel, and a cavity panel, such that the cavity panel is placed between the outer molding panel and the inner molding panel, an inner gap defined between the cavity panel and the inner molding panel, and an outer gap defined between the cavity panel and the outer molding panel, sealingly enclosing the outer molding panel, the inner molding panel, and the cavity panel with a top plate, one or more injection molding nozzles injecting resin into the inner gap and the outer gap, thereby forming an inner layer and an outer layer of a housing wall, one or more lifting devices removing the top plate and the cavity panel, one or more insulation nozzles releasing insulation material between the inner layer and the outer layer of the housing wall to form an inner insulation layer, and lowering a roof component including wall extensions extending downwardly, wherein the wall extensions are configured to align with the housing wall, wherein the wall extensions of the roof component include a plurality of elongate extruded members extending downwardly and inserting into the inner insulation layer of the housing wall.

In yet another embodiment, the present invention is directed to a system for constructing modular housing, including an outer molding panel, an inner molding panel, a cavity panel, wherein the cavity panel is placed between the outer molding panel and the inner molding panel with an inner gap defined between the cavity panel and the inner molding panel and an outer gap defined between the cavity panel and the outer molding panel, one or more injection molding nozzles configured to inject resin into the inner gap and the outer gap to form an inner layer and an outer layer of a housing wall, one or more insulation nozzles configured to release insulation material between the inner layer and the outer layer of the housing wall to form an inner insulation layer after the cavity panel is removed, and a roof component including wall extensions extending downwardly, wherein the wall extensions are configured to align with the housing wall, wherein the wall extensions of the roof component include a plurality of elongate extruded members extending downwardly, configured to insert into the inner insulation layer of the housing wall, and wherein the housing walls include a plurality of locking pins configured to engage with and stabilize the plurality of elongate extruded members.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1A illustrates an isometric sectional view of the interior of a modular home, without the roof component, constructed according to one embodiment of the present invention.

FIG. 1B illustrates a roof component for a modular home according to one embodiment of the present invention.

FIG. 1C illustrates an isometric sectional view of a modular home including a roof component constructed according to one embodiment of the present invention.

FIG. 2 illustrates a side sectional view of a connection mechanism between a modular wall panel and roof component according to one embodiment of the present invention.

FIG. 3A illustrates a side sectional view of a connection mechanism between a modular wall panel and roof component according to one embodiment of the present invention.

FIG. 3B illustrates an enlarged view of the connection mechanism of FIG. 3A.

FIG. 4 illustrates a side sectional view of a modular home including a roof component according to one embodiment of the present invention.

FIG. 5 illustrates a top view of a side walls and flooring for a modular home according to one embodiment of the present invention.

FIG. 6 illustrates a side sectional view of flooring for modular housing including a plurality of conduits according to one embodiment of the present invention.

FIG. 7A illustrates a perspective view of an exterior finish mold in an unfolded position according to one embodiment of the present invention.

FIG. 7B illustrates a perspective view of an interior finish mold being lowered within the unfolded exterior finish mold according to one embodiment of the present invention.

FIG. 7C illustrates a perspective view of an interior finish mold resting within the unfolded exterior finish mold according to one embodiment of the present invention.

FIG. 7D illustrates a perspective view of a cavity panel being lowered to slide over the interior finish mold according to one embodiment of the present invention.

FIG. 7E illustrates a perspective view of the cavity panel secured around the interior finish mold according to one embodiment of the present invention.

FIG. 7F illustrates a perspective view of the exterior finish mold in the process of folding to form an outer shell around the cavity panel according to one embodiment of the present invention.

FIG. 7G illustrates a perspective view of a mold system for forming a composite fiber housing construction with the exterior mold surround a cavity panel, which itself surrounds an interior finish mold according to one embodiment of the present invention.

FIG. 7H illustrates a perspective view of top cover plates with injection mold holes being lowered over top of the mold system according to one embodiment of the present invention.

FIG. 7I illustrates a perspective view of the mold system with the top cover plates securely fastened according to one embodiment of the present invention.

FIG. 7J illustrates a perspective view of fiber-reinforced composite extruding nozzles being lowered onto the top cover plates according to one embodiment of the present invention.

FIG. 7K illustrates a perspective view of the extruding nozzles in the process of extruding fiber-reinforced composite through top cover plates according to one embodiment of the present invention.

FIG. 7L illustrates a perspective view of the mold system post extrusion while the extruded fiber-reinforced composite bakes and cures according to one embodiment of the present invention.

FIG. 7M illustrates a perspective view of the top cover plates being removed from the mold system according to one embodiment of the present invention.

FIG. 7N illustrates a perspective view of the cavity panel being removed according to one embodiment of the present invention.

FIG. 7O illustrates a perspective view of preformed utility connection pipes being lowered into the cavity of the mold system according to one embodiment of the present invention.

FIG. 7P illustrates a perspective view of the mold system with a new top cover plate according to one embodiment of the present invention.

FIG. 7Q illustrates a perspective view of insulation nozzles being lowered onto the top cover plate according to one embodiment of the present invention.

FIG. 7R illustrates a perspective view of the mold system with the insulation nozzles and the new top cover plate removed according to one embodiment of the present invention.

FIG. 7S illustrates a perspective view of the interior finish mold being removed from the mold system according to one embodiment of the present invention.

FIG. 7T illustrates a perspective view of the exterior finish mold in the process of unfolding according to one embodiment of the present invention.

FIG. 7U illustrates a perspective view of the exterior finish mold in a fully unfolded position surrounding the finished molded wall section of the modular housing according to one embodiment of the present invention.

FIG. 7V illustrates a perspective view of the finished molded wall section of the modular housing according to one embodiment of the present invention.

FIG. 8A illustrates a perspective view of a lower panel for forming a roof section according to one embodiment of the present invention.

FIG. 8B illustrates a perspective view of locking pins being placed into specific locations in the lower panel according to one embodiment of the present invention.

FIG. 8C illustrates a perspective view of preformed insulation including utility conduits being lowered onto the lower panel according to one embodiment of the present invention.

FIG. 8D illustrates a perspective view of a top panel being placed over the preformed insulation according to one embodiment of the present invention.

FIG. 8E illustrates a perspective view of fiber reinforced plastic injection nozzles attached to and extruding through holes in the top panel for the roof section according to one embodiment of the present invention.

FIG. 8F illustrates a perspective view of the mold system for the roof section with the fiber reinforced plastic injection nozzles removed while baking and curing occurs according to one embodiment of the present invention.

FIG. 8G illustrates a perspective view of the top panel being removed from the mold system according to one embodiment of the present invention.

FIG. 8H illustrates a perspective view of the preformed roof section being lifted off of the lower panel according to one embodiment of the present invention.

FIG. 9A illustrates an enlarged perspective view of an interconnection between a wall section and a roof section of the modular housing according to one embodiment of the present invention.

FIG. 9B illustrates an enlarged perspective view of an interconnection between a wall section and a roof section of the modular housing according to one embodiment of the present invention.

FIG. 9C illustrates a perspective view of the roof section locked into place atop the wall section according to one embodiment of the present invention.

FIG. 10A illustrates a perspective view of a preformed slab panel for a flooring section, with folding sides, according to one embodiment of the present invention.

FIG. 10B illustrates a perspective view of preformed insulation with conduits for utility or plumbing being lowered onto the preformed slab panel according to one embodiment of the present invention.

FIG. 10C illustrates a perspective view of a top panel being placed over the preformed insulation according to one embodiment of the present invention.

FIG. 10D illustrates a perspective view of the top panel locked onto the preformed insulation for a flooring section according to one embodiment of the present invention.

FIG. 10E illustrates a perspective view of fiber-reinforced polymer extruding nozzles lowered onto and extruding into the flooring mold system according to one embodiment of the present invention.

FIG. 10F illustrates a perspective view of the flooring mold system with the fiber-reinforced polymer extruding nozzles removed while the mold bakes and cures according to one embodiment of the present invention.

FIG. 10G illustrates a perspective view of the top panel being removed from the flooring mold system according to one embodiment of the present invention.

FIG. 10H illustrates a perspective view of the sides of the preformed slab panel being lowered and unfolded according to one embodiment of the present invention.

FIG. 10I illustrates a perspective view of a finished floor slab according to one embodiment of the present invention.

### DETAILED DESCRIPTION

The present invention is generally directed to modular building construction connectors, and more specifically to connectors for modular housing utilizing fiberglass or other fiber-reinforced materials.

In one embodiment, the present invention is directed to a system for constructing modular housing, including an outer molding panel, an inner molding panel, a cavity panel, wherein the cavity panel is placed between the outer molding panel and the inner molding panel with an inner gap defined between the cavity panel and the inner molding panel and an outer gap defined between the cavity panel and the outer molding panel, a top plate, configured to sealingly enclose the outer molding panel, the inner molding panel, and the cavity panel, one or more injection molding nozzles configured to inject resin into the inner gap and the outer gap to form an inner layer and an outer layer of a housing wall, one or more lifting devices configured to remove the top plate and the cavity panel, one or more insulation nozzles configured to release insulation material between the inner layer and the outer layer of the housing wall to form an inner insulation layer, and a roof component including wall extensions extending downwardly, wherein the wall extensions are configured to align with the housing wall, wherein the wall extensions of the roof component include a plurality of elongate extruded members extending downwardly, configured to insert into the inner insulation layer of the housing wall.

In another embodiment, the present invention is directed to a method for constructing modular housing, including placing an outer molding panel, an inner molding panel, and a cavity panel, such that the cavity panel is placed between the outer molding panel and the inner molding panel, an inner gap defined between the cavity panel and the inner molding panel, and an outer gap defined between the cavity panel and the outer molding panel, sealingly enclosing the outer molding panel, the inner molding panel, and the cavity panel with a top plate, one or more injection molding nozzles injecting resin into the inner gap and the outer gap, thereby forming an inner layer and an outer layer of a housing wall, one or more lifting devices removing the top plate and the cavity panel, one or more insulation nozzles releasing insulation material between the inner layer and the outer layer of the housing wall to form an inner insulation layer, and lowering a roof component including wall extensions extending downwardly, wherein the wall extensions are configured to align with the housing wall, wherein the wall extensions of the roof component include a plurality of elongate extruded members extending downwardly and inserting into the inner insulation layer of the housing wall.

In yet another embodiment, the present invention is directed to a system for constructing modular housing, including an outer molding panel, an inner molding panel, a cavity panel, wherein the cavity panel is placed between the outer molding panel and the inner molding panel with an inner gap defined between the cavity panel and the inner molding panel and an outer gap defined between the cavity panel and the outer molding panel, one or more injection molding nozzles configured to inject resin into the inner gap and the outer gap to form an inner layer and an outer layer of a housing wall, one or more insulation nozzles configured to release insulation material between the inner layer and the outer layer of the housing wall to form an inner insulation layer after the cavity panel is removed, and a roof component including wall extensions extending downwardly, wherein the wall extensions are configured to align with the housing wall, wherein the wall extensions of the roof component include a plurality of elongate extruded members extending downwardly, configured to insert into the inner insulation layer of the housing wall, and wherein the housing walls include a plurality of locking pins configured to engage with and stabilize the plurality of elongate extruded members.

The construction industry is volatile in nearly every aspect. The pricing and availability of building materials fluctuates constantly and is unpredictable. Building projects are subject to changing labor costs and in some instances, labor shortages. The construction timetable is dependent on numerous unknowable factors, including necessary inspections, supply chain issues, timely performance of contractors and subcontractors, weather at the site, and other disruptions construction site. Furthermore, traditional construction requires specific workflow wherein one phase of construction cannot begin without completion of the previous phase. Because of this, site excavation must be completed before construction of the structure is able to begin.

To address some of these issues, some in the industry have utilized modular construction. Modular construction is sometimes referred to as prefabricated construction, pre-panelized construction, or other terms. Generally, modular constructions consist of fabricating some or all of a building offsite in a controlled environment then transporting the pre-fabricated elements to the site for quick assembly. In some cases, particularly with smaller single-family homes, the entire structure may be manufactured offsite, transported to the site, and installed in place. In other cases, various portions of the building are constructed off-site then are assembled onsite in a particular manner. All or some of the building is able to be prefabricated.

With modular construction, some or all of a build is constructed in a controlled indoors environment at an offsite factory or the like. This eliminates weather delays or other potential obstacles associates with construction onsite. Furthermore, construction of the building is able to begin offsite while the site is still be excavated or otherwise prepared. In other words, modular construction does not have to proceed as linearly as traditional construction, which increases efficiency and reduces construction time and costs. Furthermore, being able to produce buildings in more assembly line manner further increases efficiency and reduces costs. For example, with this assembly line manufacturing system, one factory is able to produce the same line of modular single-family houses in repetition.

Despite the advantages of modular construction, many drawbacks still exist that have, so far, prevented modular construction from becoming widespread. First, finding the right materials for modular construction is difficult. Traditional building materials are not ideal for prefabrication. Builders have struggled with finding and working with effective materials, and assembly of prefabricated pieces has compounded these issues. Difficulties in utilizing effective materials and in assembling the prefabricated components often neutralizes the theoretical advantages of modular housing, namely reduced costs and increased efficiency. These issues are large enough that modular construction projects still only account for a small minority of construction projects, limiting the potential of this technology.

The basic components of the modular home include flooring, a plurality of wall panels, and a roof component. Unlike existing prior art modular construction, which typically utilizes wood, steel, or concrete components, the present invention includes wall panels and/or flooring constructed from one or more fiber-reinforced plastic materials. In a preferred embodiment, the fiber-reinforced plastic materials include fiberglass-reinforced plastic (FRP), but in another embodiment, the fiber-reinforced plastic materials include carbon fiber reinforced plastic (CFRP), basalt fiber reinforced plastic (BFRP), aramid reinforced plastic, and/or other fiber-reinforced plastic materials. Examples of matrix polymers operable to be used for the fiber-reinforced plastic materials used according to the present invention include, but are not limited to, polyesters, epoxides, polyamides, polycarbonates, polyoxymethylene, polypropylene, polybutylene terephthalate (PBT), polystyrene, polyvinylchloride (PVC), and/or vinyl esters. Types of glass fibers able to be used in the FRP include E-Glass, E-CR-Glass, A-Glass, D-Glass, R-Glass, S-Glass, S+R-Glass, C-Glass, and/or any other type of glass fiber known in the art. The fiber-reinforced plastic material is able to include fiber laid up in various orientations, including unidirectional layups and weave layups with various densities of fiber. In one embodiment, the fiber-reinforced plastic material includes a plurality of layers, wherein each layer includes the same or different orientations of reinforcement fiber (e.g., a first layer includes unidirectional fiber in a first direction, a second layer includes unidirectional fiber in a second direction orthogonal to the first direction, etc.).

The components of the present invention are operable to be constructed using biocomposites in one embodiment of the present invention. By way of example, and not limitation, biochar, biomass, or plant fibers are included in the composites of the present invention. Advantageously, inclusion of this material provides for carbon sequestration in the structures of the present invention. Agricultural waste products from farming corn, rice, soybeans, and other products must be disposed. These waste products are traditionally disposed of in a manner which does not provide any value. By incorporating these waste products into the components of the present invention, advantageous mechanical and chemical properties are achieved in the resulting structures. These properties are operable to be customized by inclusion of different biocomposites or agricultural waste products in different ratios or percentages with other components.

The components of the present invention, including wall, floor, ceiling, and conduit components, and the resulting structures formed of these components, are ultraviolet (UV) resistant, fireproof or fire retardant, and waterproof. These components preferably form an air barrier, water barrier, vapor barrier, and/or thermal barrier, and are also operable to provide a sound barrier.

The wall panels are preferably formed such that they include an internal fiber-reinforced layer facing an interior of the housing and an external fiber-reinforced layer, facing an exterior of the housing. The internal layer and the external layer are preferably separated by a distance and are preferably substantially parallel planes, allowing for the inclusion of a layer of insulation (e.g., thermal insulation and/or acoustic insulation) between the internal layer and the external layer. In a preferred embodiment, the internal layer and the external layer are formed from substantially the same material (e.g., the same type of fibers, the same polymer matrix, the same or similar layup, etc.), while, in another embodiment, the internal layer and the external layer are not formed from the same material (e.g., different fibers and/or polymer matrix material) or have different orientations (e.g., different layup or sub-layering). In a preferred embodiment, the layer of insulation is an open cell foam insulation layer (e.g., reticulated foam, polyurethane foam, open cell rubber, etc.). However, in another embodiment, the insulation includes a closed cell foam insulation layer (e.g., ethylene propylene diene terpolymer (EPDM), vinyl nitrile foam (PVC/NBR), etc.), a rigid foam insulation layer (e.g., expanded polystyrene (EPS), extruded polystyrene (XPS), polyisocyanurate (ISO), etc.), a cellulose insulation layer (e.g., cotton, sheep wool, hemp, etc.), a mineral wool insulation layer, a perlite insulation layer. In one embodiment, the layer of insulation is applied as a spray foam insulation layer.

In one embodiment, the wall panels include one or more conduits extending through the space between the internal layer and the external layer. These conduits are hollow tubes extending through the height of the wall panels, preferably substantially straight vertically (i.e., orthogonal to the flooring). The conduits facilitate the inclusion of wiring (e.g., electrical wiring, telephone wiring, internet cable wiring, etc.) in the modular structure without the need for more complicated installation and preferably reduce or eliminate the number of cutouts or holes which must be formed in the structure for wiring. The modular structures of the present invention are operable to include openings for accepting outlets and fixtures such as sinks and faucets in one embodiment. These openings are preferably integrally formed with the modular structure. In one embodiment, the wall panel conduits included in the wall panels are configured to substantially align with a roof component connected to the wall panels and/or with conduits in a flooring connected to the wall panels. In one embodiment, the shells of the conduits are formed from fiber-reinforced plastic material, preferably the same fiber-reinforced plastic material as the internal layer and the external layer of the wall panels. In one embodiment, the conduits are integrally formed with the internal layer and the external layer of the wall panels. Preferably, the conduits serve a multi-purpose role of providing structural reinforcement of the wall panels, connecting the internal layer and the external layer of the wall panels, and for serving as a conduit for wiring as discussed above. One of ordinary skill in the art will understand that the conduits are able to have any suitable cross-sectional geometry (e.g., circular, square, hexagonal, triangular, etc.) and are able to be sized and shaped as appropriate to provide sufficient supporting and facilitate wiring.

The flooring of the modular housing is preferably formed such that it includes an upper fiber-reinforced layer facing an interior of the housing and a lower fiber-reinforced layer, facing the ground or earth. The upper layer and the lower layer are preferably separated by a distance and are preferably substantially parallel planes, allowing for the inclusion of a layer of insulation (e.g., thermal insulation and/or acoustic insulation) between the upper layer and the lower layer. In a preferred embodiment, the upper layer and the lower layer are formed from substantially the same material (e.g., the same type of fibers, the same polymer matrix, the same or similar layup, etc.), while, in another embodiment, the upper layer and the lower layer are not formed from the same material (e.g., different fibers and/or polymer matrix material) or have different orientations (e.g., different layup or sub-layering). In a preferred embodiment, the layer of insulation is an open cell foam insulation layer (e.g., reticulated foam, polyurethane foam, open cell rubber, etc.). However, in another embodiment, the insulation includes a closed cell foam insulation layer (e.g., ethylene propylene diene terpolymer (EPDM), vinyl nitrile foam (PVC/NBR), etc.), a rigid foam insulation layer (e.g., expanded polystyrene (EPS), extruded polystyrene (XPS), polyisocyanurate (ISO), etc.), a cellulose insulation layer (e.g., cotton, sheep wool, hemp, etc.), a mineral wool insulation layer, a perlite insulation layer. In one embodiment, the layer of insulation is applied as a spray foam insulation layer.

In one embodiment, the flooring includes one or more conduits extending through the space between the upper layer and the lower layer. These conduits are hollow tubes extending through at least a portion of the flooring, preferably substantially straight horizontally (i.e., orthogonal to the wall panels). The conduits facilitate the inclusion of wiring (e.g., electrical wiring, telephone wiring, internet cable wiring, etc.) in the modular structure without the need for more complicated installation. In one embodiment, the flooring conduits included in the flooring are configured to connect with and are aligned with the wall panel conduits in the wall panels. In one embodiment, the shells of the conduits are formed from fiber-reinforced plastic material, preferably the same fiber-reinforced plastic material as the upper layer and the lower layer of the flooring. In one embodiment, the conduits are integrally formed with the upper layer and the lower layer of the flooring. Preferably, the conduits serve a multi-purpose role of providing structural reinforcement for the flooring, connecting the upper layer and the lower layer of the flooring, and for serving as a conduit for wiring as discussed above.

Furniture is operable to be integrally formed as part of the flooring in one embodiment. For example, chairs, sofas, counters, islands, desks, platforms, bed bases, tables, and any other known furniture component is operable to be integrally formed and connected to the flooring.

Preferably, the modular construction of the present invention includes the unique construction of integrally forming one or more of the wall panels (and preferably each of the wall panels) with the flooring. In this embodiment, the upper layer of the flooring is continuous with the inner layers of the wall panels and the lower layer of the flooring is continuous with the outer layers of the wall panels. In this embodiment, each layer of the wall panels and the flooring are all integrally formed together and therefore preferably, though not necessarily, are formed from the same materials (e.g., the same fiber and matrix materials for the fiber-reinforced plastics). In one embodiment, the flooring conduits are continuous with wall panel conduits in one or more of the wall panels, providing for easier orientation and connectivity of the wiring in the modular housing. One of ordinary skill in the art will understand that the wall panels integrally formed with the flooring are able to include, but are not necessarily limited to, external walls of the housing structure, but are also able to include internal walls dividing different rooms of the housing. In one embodiment, the overall housing is able to include a plurality of combined flooring and wall panels structures organized laterally to one another. In this embodiment, rather than shipping and constructing the housing as a plurality of panels, the housing is instead able to effectively be put together onsite as a series of attached rooms, limiting the amount of assembly required. In one embodiment, the maximum size and/or number of rooms created as a single molded unit is determined by a maximum shipping size (e.g., by maximum shipping dimensions permitted by the United States Department of Transportation). However, in another embodiment, the entire flooring and all wall panels of the housing is constructed as a single component, whether or not the housing includes a plurality of rooms or only a single room.

In one embodiment, the combined structure of the flooring with one or more of the wall panels is formed via a molding technique. In one embodiment, the combined structure of walls and flooring is formed via an injection molding technique. In another embodiment, the combined structure of walls and flooring is formed via a vacuum molding technique. In yet another embodiment, the combined structure of walls and flooring is formed via a cast molding technique. In still another embodiment, the combined structure of walls and flooring is formed via an extrusion molding technique. In one embodiment, the intersection of the one or more wall panels and the flooring is not an exact 90 degree, but is rather curved to a degree so as to facilitate greater ease in the molding technique. In a preferred embodiment, the molding technique and other manufacturing of the combined structure of the flooring and one or more wall panels is performed by an automated robotic mechanism configured to add material to the mold, apply pressure or heat as needed, and/or subsequently remove the structure from the mold.

In one embodiment, the present invention is not limited to only constructing the wall panels and floor as a common unit and is able to further integrally construct one or more articles of furniture within the home as part of the same molding process. For example, in one embodiment, one or more chairs, sofas, tables, countertops, cabinets, stairs, beds and/or other interior elements of the home are integrally formed with the flooring of the modular construction. This applies both to embodiments where the wall panels and flooring are integrally formed and those where the flooring and wall panels are constructed separately as individual molded components. This provides users with functional furniture components without the need for some furniture to be separately purchased by the homeowner, having particular utility in low-income housing. Alternatively, in one embodiment, such furniture is not integrally formed with the flooring or the wall panels and traditional furniture is entirely used in the housing.

Referring now to the drawings in general, the illustrations are for the purpose of describing one or more preferred embodiments of the invention and are not intended to limit the invention thereto.

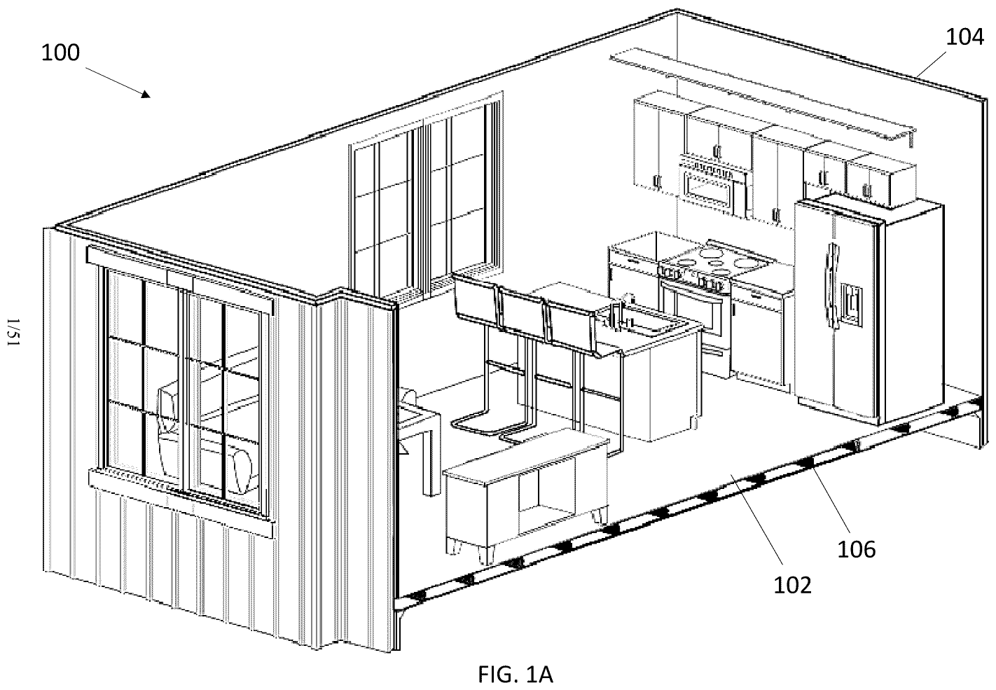

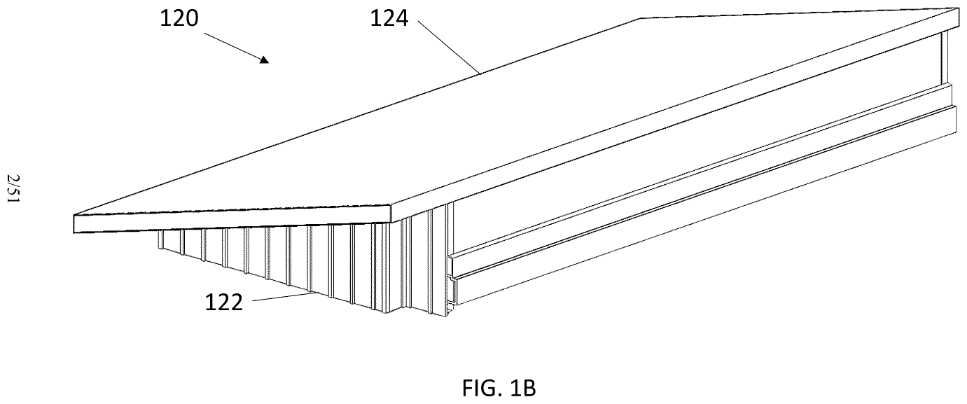

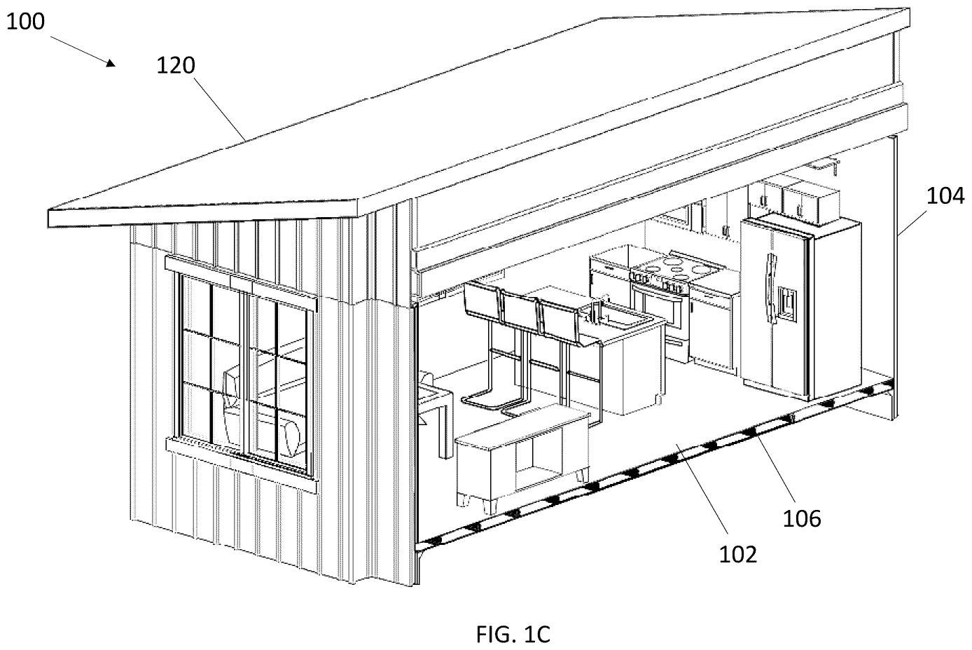

FIG. 1A illustrates an isometric sectional view of the interior of a modular home, without the roof component, constructed according to one embodiment of the present invention. The modular home 100 shown in FIG. 1A includes a flooring 102 connected to a plurality of wall panels 104. In one embodiment, the flooring 102 and the plurality of wall panels 104 are connected via one or more connectors, including but not limited to, adhesive, bolts, screws, nails, and/or other connection mechanisms known in the art. However, in a preferred embodiment, the flooring 102 and the plurality of wall panels 104 are integrally formed and are not required to be constructed at the building site. As shown in FIG. 1A, in one embodiment, the flooring 102 includes a plurality of conduits 106 providing structural support and access areas for electrical cabling to the modular housing 100.

FIGS. 1B-1C illustrate a roof component for a modular home separate and connected to the rest of the modular home according to one embodiment of the present invention. A roof component 120 configured to be placed on top of the housing includes one or more partial wall panels 122 extending downwardly from a top panel 124 of the roof component 120. These partial wall panels 122 are configured to align with and connect with the wall panels of the combined wall panel-flooring construction. In one embodiment, similarly to the wall panels of the combined wall panel-flooring construction, the partial wall panels 122 of the roof component 120 includes a plurality of interior conduits also configured to align with and connect with conduits in the rest of the wall panels, thereby allowing electrical connections to extend into the roof component 120. This is particularly useful and important for satellite dishes, solar panels, and/or other electrical devices on the roof component 120.

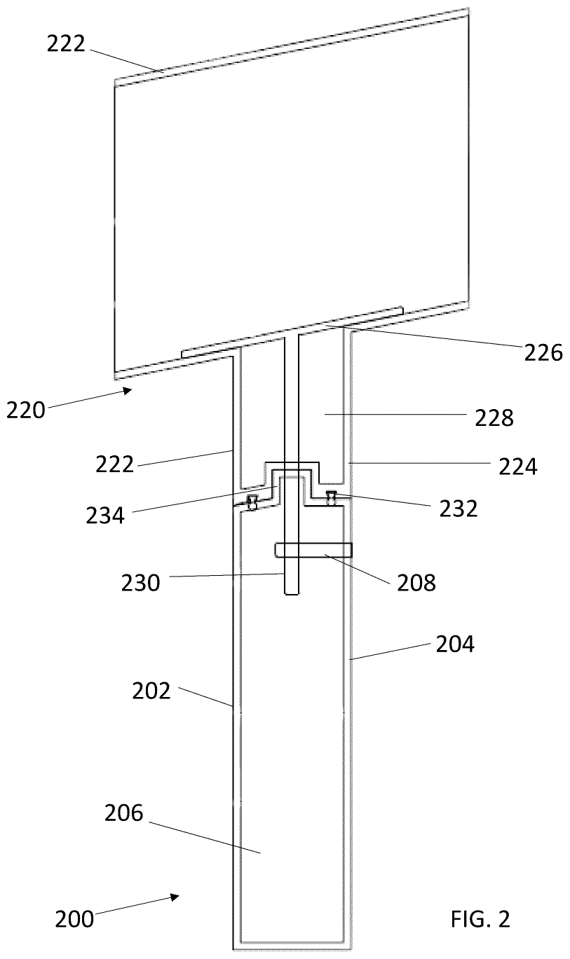

FIG. 2 illustrates a side sectional view of a connection mechanism between a modular wall panel and roof component according to one embodiment of the present invention. A wall panel 200 extending upwardly from flooring of the modular home includes an exterior fiber-reinforced plastic layer 202 and an interior fiber-reinforced plastic layer 204, with an insulation layer 206 positioned between the exterior layer 202 and the interior layer 204. In one embodiment, the exterior layer 202 is a 0.25 in thick fiberglass layer. In one embodiment, the interior layer 204 is a 0.25 in thick fiberglass layer. In one embodiment, the insulation layer 206 includes an open cell foam insulation material. In one embodiment, a locking pin 208 extends inwardly into the insulation layer 206 from the interior layer 204 or the exterior layer 202. In one embodiment, the locking pin 208 is a steel rod.

In one embodiment, the exterior layer 202 and the interior layer 204 are connected and continuous via a layer of fiberglass extending over a top of the wall panel 200. In one embodiment, the top of the wall panel 200 includes an extension 234 extending upwardly from the top of the wall panel 200. Preferably, the extension 234 is configured (e.g., sized and shaped) to act as a tenon tongue configured to fit into a mortise hole in a wall panel section of a roof component 220, thereby forming a mortise and tenon joint.

The roof component 220 includes a top section 222 configured to cover a top of the housing with a plurality of short wall panel sections extending downwardly from the top section 222. In one embodiment, the top section 222 includes an exterior fiber-reinforced plastic shell (e.g., 0.25 in. fiberglass shell) and an insulation material interior (e.g., open cell foam insulation). The wall panel sections include a fiber-reinforced plastic exterior layer 222 and a fiber-reinforced plastic interior layer 224, with an insulation layer 228 positioned between the exterior layer 22 and the interior layer 224. Similar to the wall panel 200, the exterior layer 222 and the interior layer 224 are connected and continuous via a layer of fiberglass covering a bottom of the wall panel section. In one embodiment, the bottom of the wall panel section includes a recess extending upwardly into the insulation layer 228, i.e., a mortise, configured (e.g., sized and shaped) to fit the extension 234 extending upwardly from the wall panel 200.

The roof component is operable to include integrally formed gutters which connect to integrally formed gutter components, including downspouts, in wall components. The integrally formed gutters are operable to be open channels formed at the edge of the roof component, with corresponding closed vertical channels formed in the wall components which connect to the channels of the roof. In one embodiment, the present invention includes an integrally formed water storage component or provide for a connection from a gutter component to a water storage component, such as a rain barrel or other container. In this manner, the present invention supports water collection for emergency scenarios in which water access is not available.

In one embodiment, the thickness of the interior layer 224 of the wall panel section of the roof component 220 is configured to be of substantially the same thickness as the thickness of the interior layer 204 of the wall panel 200. In one embodiment, the thickness of the exterior layer 222 of the wall panel section of the roof component is configured to be of substantially the same thickness as the thickness of the exterior layer 202 of the wall panel 200. In one embodiment, the thickness of the insulation layer 228 of the wall panel section of the roof component 220, and therefore the distance between the interior layer 224 and the exterior layer 222, is substantially the same thickness as the thickness of the insulation layer 206 of the wall panel 200. The equivalency of these dimensions allows the wall panel section of the roof component 220 to substantially match and align with the wall panel 200 when the components are fit together, allowing for a smooth appearance and sufficient insulative properties. In one embodiment, the insulation layer 228 in the wall panel section of the roof component 220 includes substantially the same material as the insulation layer 206 in the wall panel 200. In one embodiment, the interior layer 224 and the exterior layer 222 are continuous with an exterior shell layer of the top of the roof component 220.

In one embodiment, an elongate extruded member 230 (preferably a fiberglass component) extends downwardly from a top 222 of the roof component 220 through the insulation layer 228 past the bottom of the wall panel section of the roof component 220. In one embodiment, the top of the elongate extruded member 230 extends horizontally such that it covers the entire top of the insulation layer 228, separating the wall panel section of the roof component 220 and the top section 222 of the roof component 220. When the roof component 220 is joined to the wall panel 200, the elongate extruded member 230 extends through an opening in the top of the wall panel 200 into the insulation layer 206 of the wall panel 200. In one embodiment, the locking pin 208 in the wall panel 200 is configured to attach to and interlock with the elongate extruded member 230 from the roof component 220 to help hold the two components together.

In one embodiment, at least one weatherstrip 232 is attached to a top of the wall panel 200 and/or to a bottom of the wall panel section of the roof component 220. When the roof component 220 is attached to the wall panel 200, the at least one weatherstrip 232 compresses between the components, forming a weather resistant barrier and seal between the components, allowing for heat to remain trapped within the housing more easily, and preventing water, heat, or particulates from entering the housing through the connection. In one embodiment, the at least one weatherstrip 232 is a circular strip surrounding the mortise-tenon joint. In another embodiment, the at least one weatherstrip 232 includes a first strip positioned closer to the exterior of the housing relative to the mortise-tenon joint and a second strip positioned closer to the interior of the housing relative to the mortise-tenon joint.

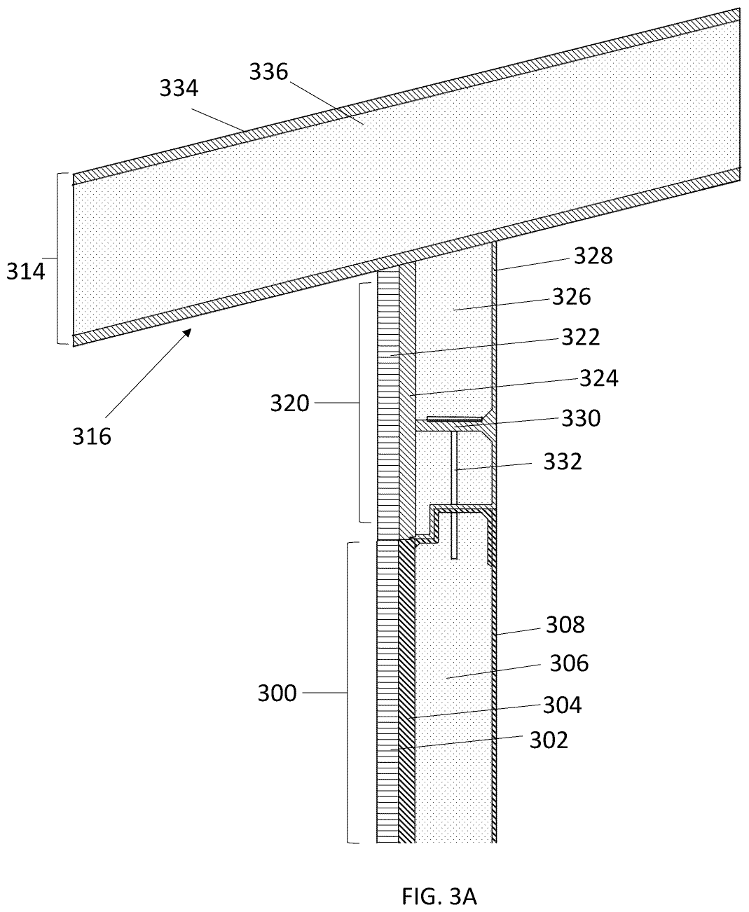

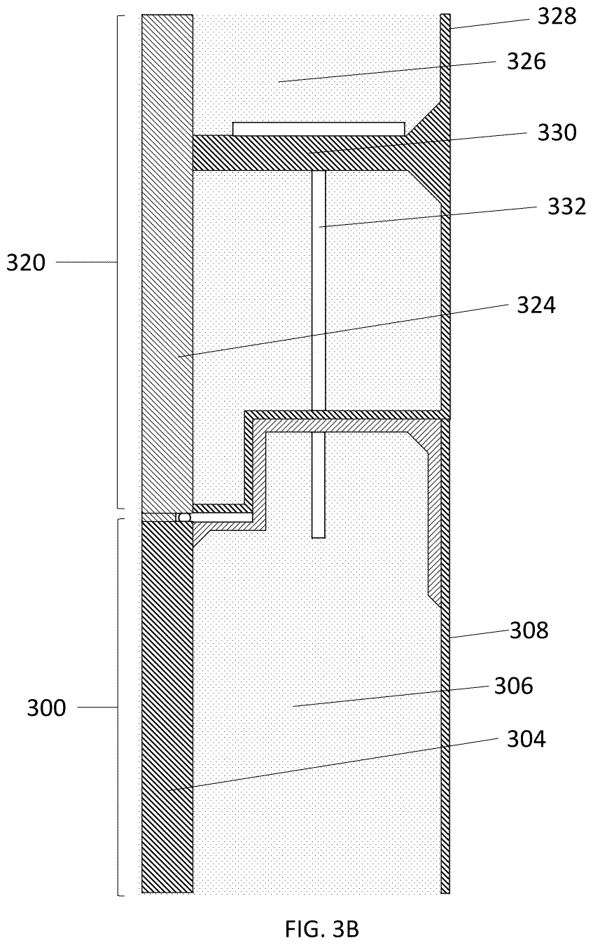

FIGS. 3A and 3B illustrate a side sectional view of a connection mechanism between a modular wall panel and roof component according to one embodiment of the present invention. In one embodiment, the roof component 316 includes a short wall panel section 320 extending downwardly from a top section 314. Similar to the embodiment shown in FIG. 2, the wall panel section 320 includes a fiber-reinforced plastic exterior layer 324 and a fiber reinforced plastic interior layer 328. The exterior layer 324 and the interior layer 328 are separated by an insulation layer 326, and the insulation layer 326 is preferably filled with at least one insulation material (e.g., open cell foam insulation). In one embodiment, the exterior layer 324 has a thickness of approximately 0.75 in. and the interior layer 328 has a thickness of approximately 0.125 in. In one embodiment, the insulation layer has a thickness of approximately 3.625 in. In one embodiment, an outer shielding layer 322 is positioned on an exterior side of the fiber-reinforced plastic exterior layer 324 and is able to serve as an additional support and/or weather-resistant barrier for the housing.

In one embodiment, the top section 314 includes an exterior fiber-reinforced plastic shell 334 and an interior space or insulation layer 336. In one embodiment, the exterior fiber-reinforced plastic shell 334 has a thickness of approximately 0.5 in. on all sides of the interior space or insulation layer 336. In one embodiment, the insulation layer 336 has a thickness of approximately 6.75 in.

The short wall panel section 320 of the roof component 316 is configured to matingly connect with a wall panel 300. Similar to the short wall panel section 320, the wall panel 300 includes a fiber-reinforced plastic exterior layer 304 and a fiber-reinforced plastic interior layer 308, separated by an insulation layer 306. In one embodiment, an outer shielding layer 302 is positioned on an exterior side of the fiber-reinforced plastic exterior layer 304 and is able to serve as an additional support and/or weather-resistant barrier for the housing. In one embodiment, the exterior layer 304 has a thickness of approximately 0.75 in. and the interior layer 308 has a thickness of approximately 0.125 in. In one embodiment, the insulation layer has a thickness of approximately 3.625 in. Preferably, the dimensions of each layer are matched between the short wall panel section 320 and the wall panel 300 to ensure a close and smooth fit between the components. Preferably, the interior layer 308 and the exterior layer 304 of the wall panel 300 are connected, or even continuous, by a fiberglass layer covering the top of the wall panel 300. Similarly, the interior layer 328 and the exterior layer 324 of the short wall panel section 320 are connected, or even continuous, by a fiber glass layer covering the bottom of the short wall panel section 320.

In one embodiment, prongs 330 extend inwardly from the interior layer 328 and bridge the gap between the interior layer 328 and the exterior layer 324. In one embodiment, the prongs 330 includes openings through which a protrusion 332 is configured to extend. The protrusion 332 preferably includes a thin stalk extending through the opening of the prong 330 and a large flat base having a size greater than the opening to secure the protrusion 332 in place. The protrusion 332 extends through the insulation layer 336 into an insulation layer 306 of the wall panel 300. The protrusions 332 further extend through aligned openings in the bottom of the short wall panel section 320 and the top of the wall panel 300 and into the insulation layer 306 of the wall panel 300.

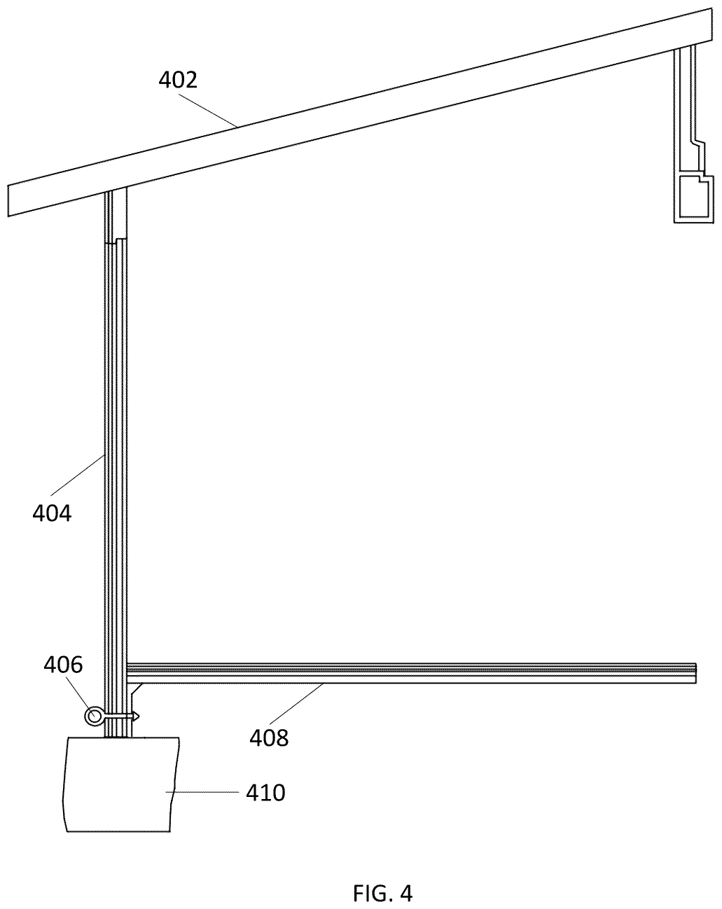

FIG. 4 illustrates a side sectional view of a modular home including a roof component according to one embodiment of the present invention. In one embodiment, a roof component 402 is connected with one or more wall panels 404. In the embodiment shown in FIG. 4, at least one of the wall panels 404 and the flooring 408 are not integrally formed. Instead. The flooring 408 includes external securing components extending downwardly from an exterior of the flooring 408 toward a slab 410. In one embodiment, the wall panel 404 connects to the external securing components of the flooring 408 via one or more pins 406.

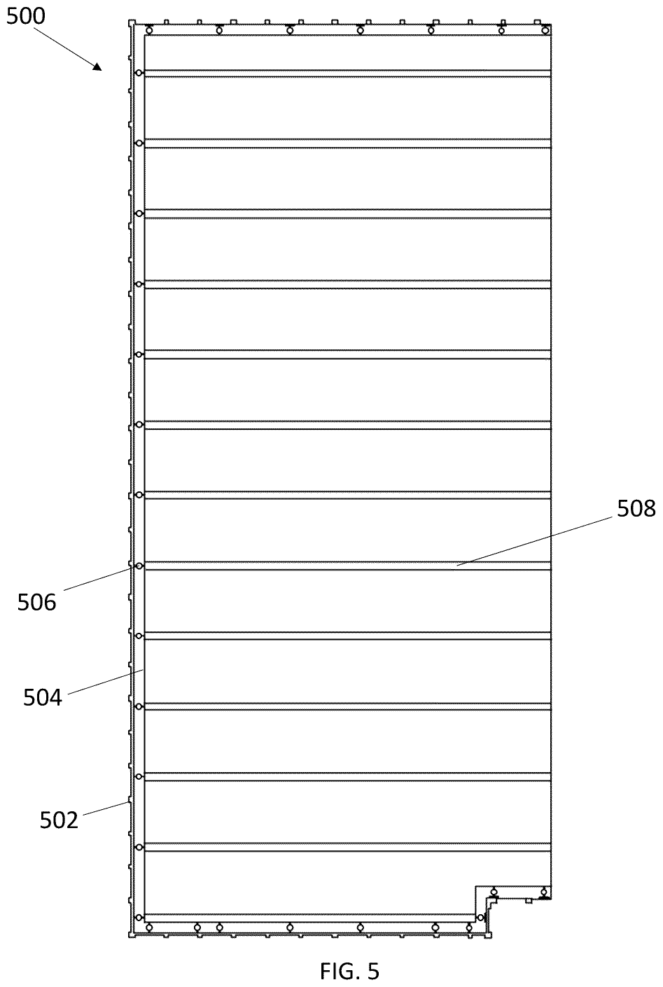

FIG. 5 illustrates a top view of a side walls and flooring for a modular home according to one embodiment of the present invention. As shown in FIG. 5, according to one embodiment of the present invention, a housing unit 500 includes wall panels having an exterior layer 502 and an interior layer 506. A plurality of hollow conduits 506 extend upwardly through the wall panels between exterior layer 502 and the interior layer 506. Additionally, a plurality of hollow conduits 508 extend laterally through the flooring of the housing unit 500. Preferably, at least a subset, if not all, of the hollow conduits 508 extending through the flooring connect to, or are even continuous with, the plurality of hollow conduits 506 in the wall panel.

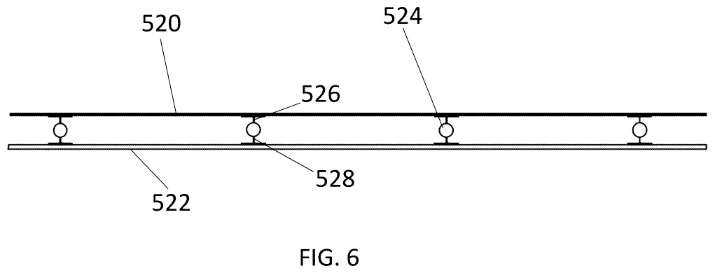

FIG. 6 illustrates a side sectional view of flooring for modular housing including a plurality of conduits according to one embodiment of the present invention. As shown in FIG. 6, in a preferred embodiment, a plurality of hollow conduits 524 extend laterally between a top layer 520 and a bottom layer 522 of the flooring. In one embodiment, the hollow conduits 524 are connected to the top layer 520 by a first extension 526 and are connected to the bottom layer 522 by a second extension 528. In one embodiment, the hollow conduits 524, the first extension 526, the second extension 528, the top layer 520, and the bottom layer 522 are all integrally formed from a fiber-reinforced plastic material.

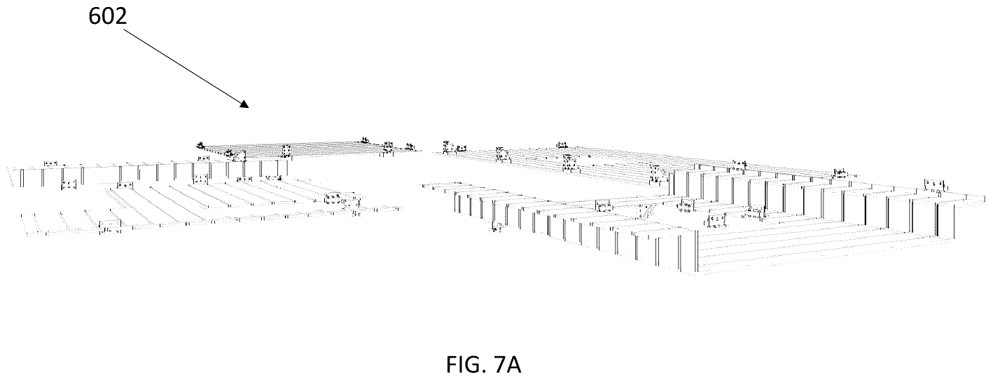

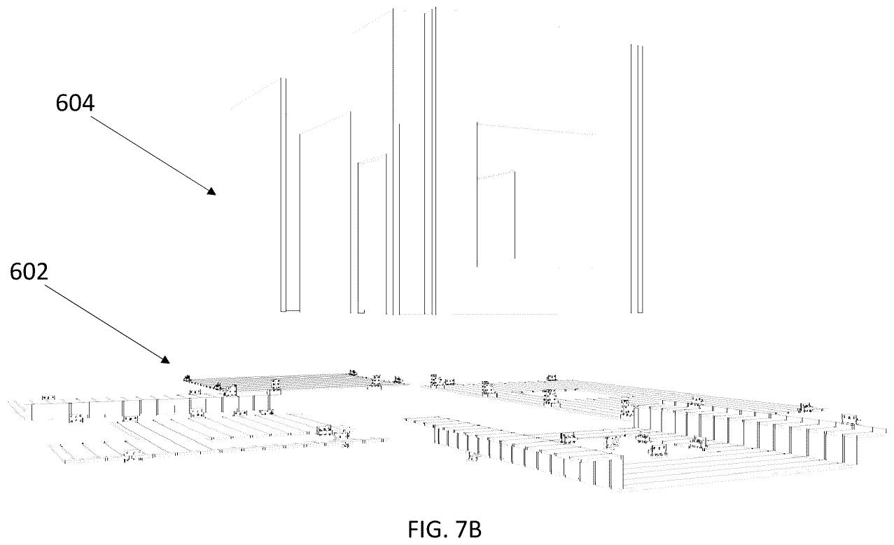

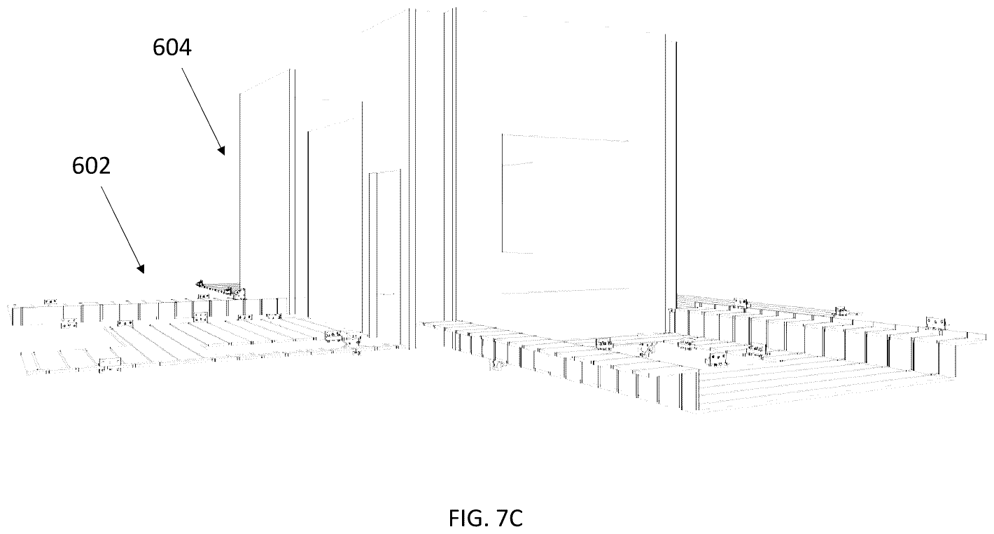

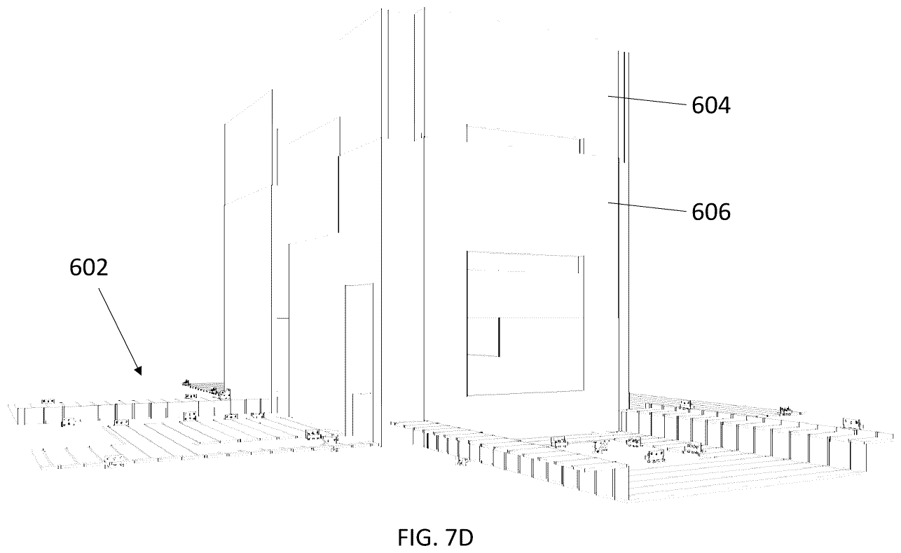

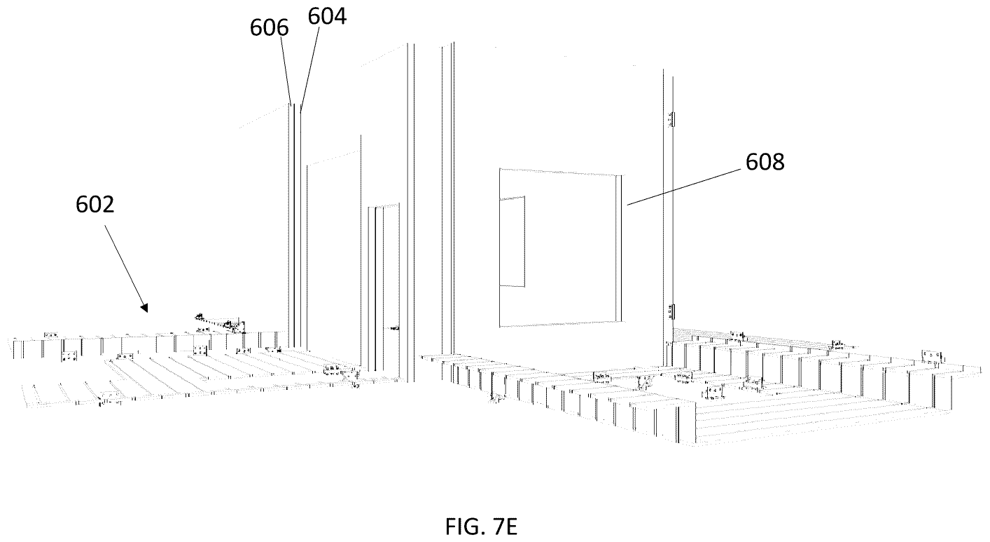

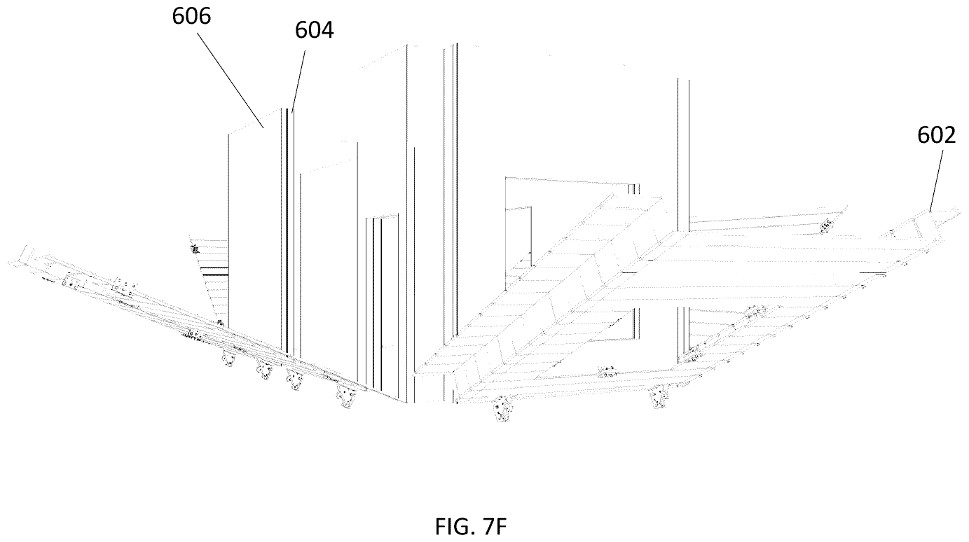

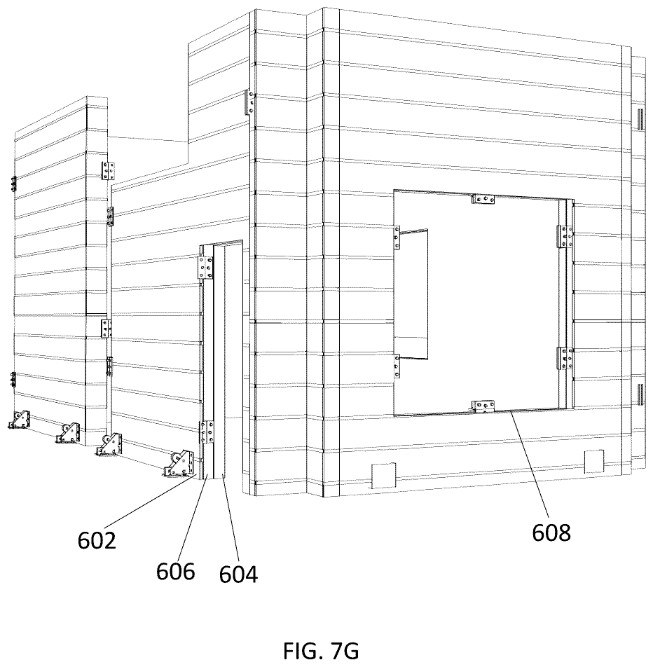

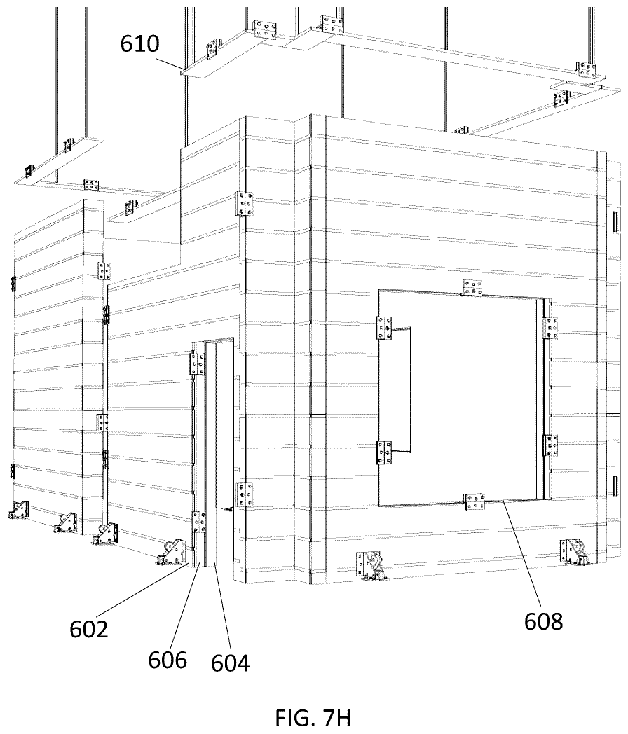

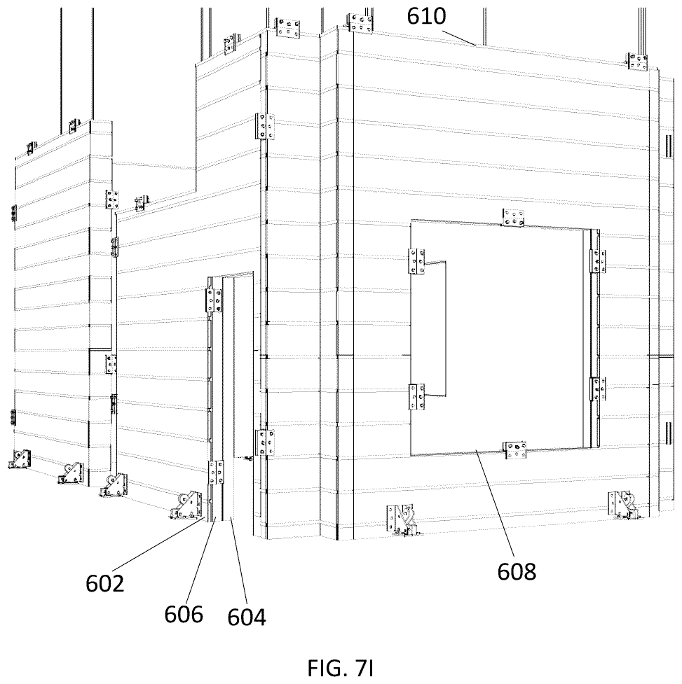

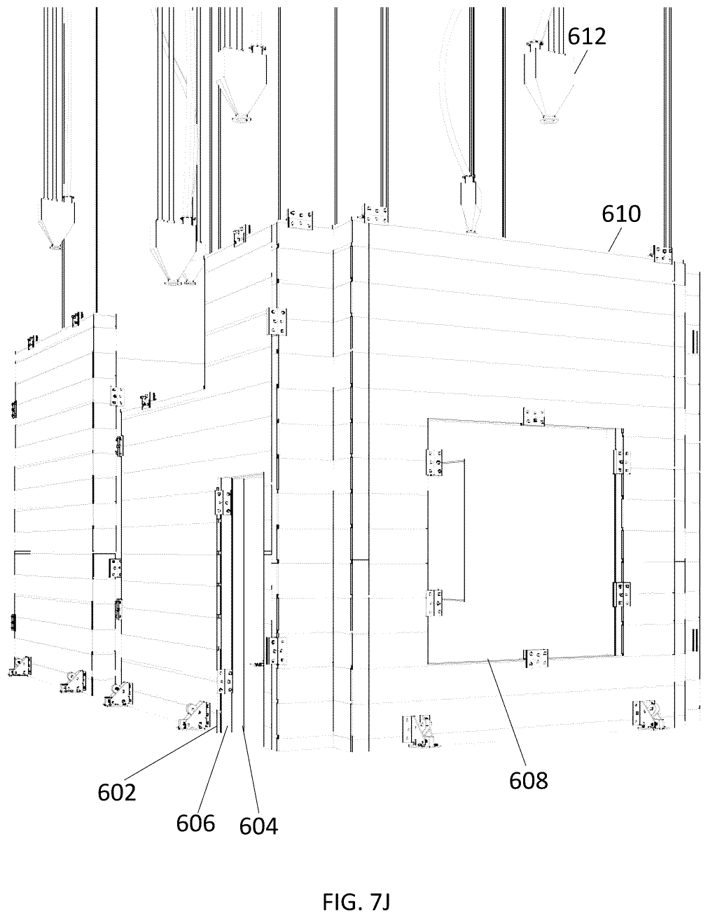

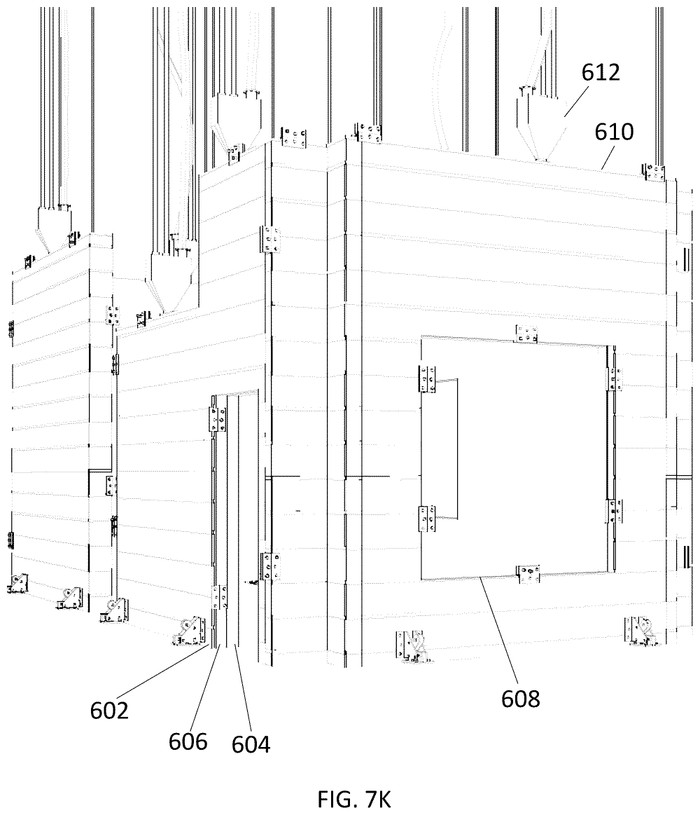

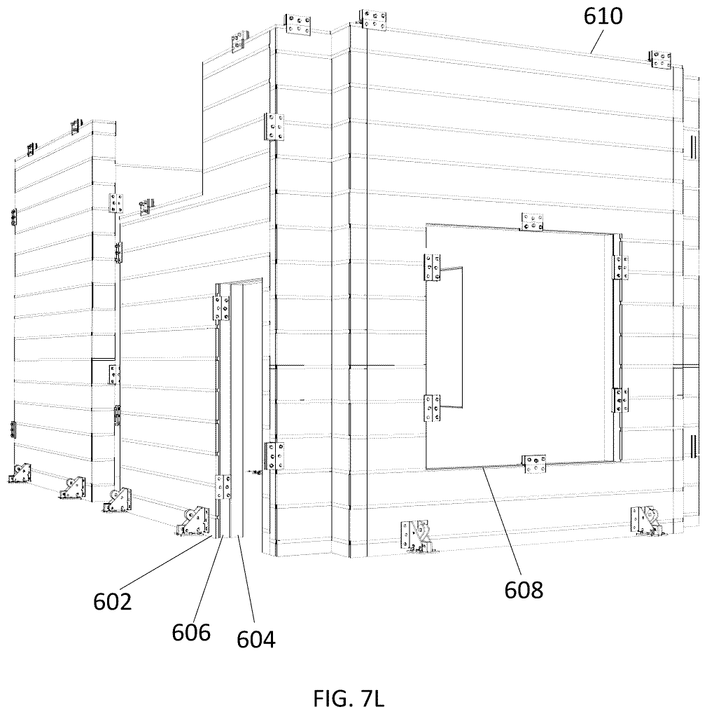

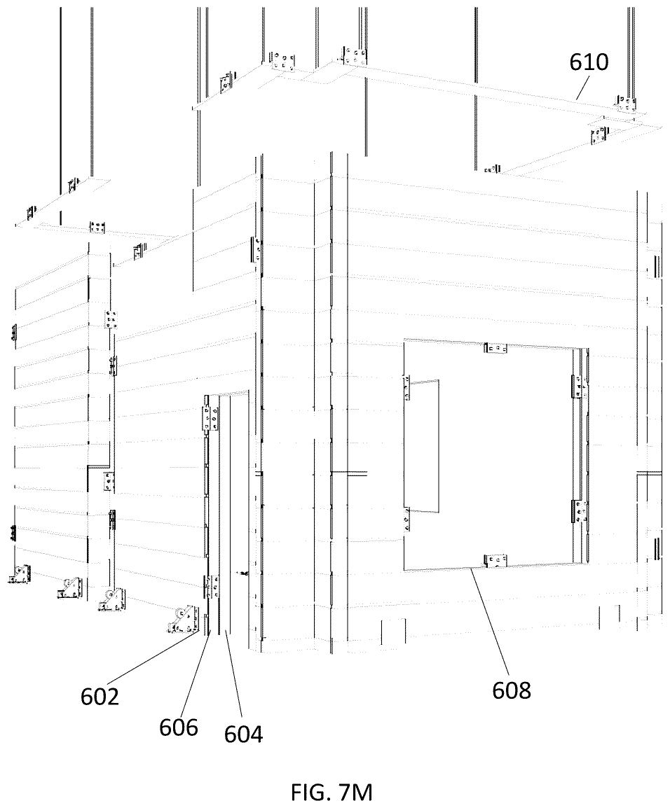

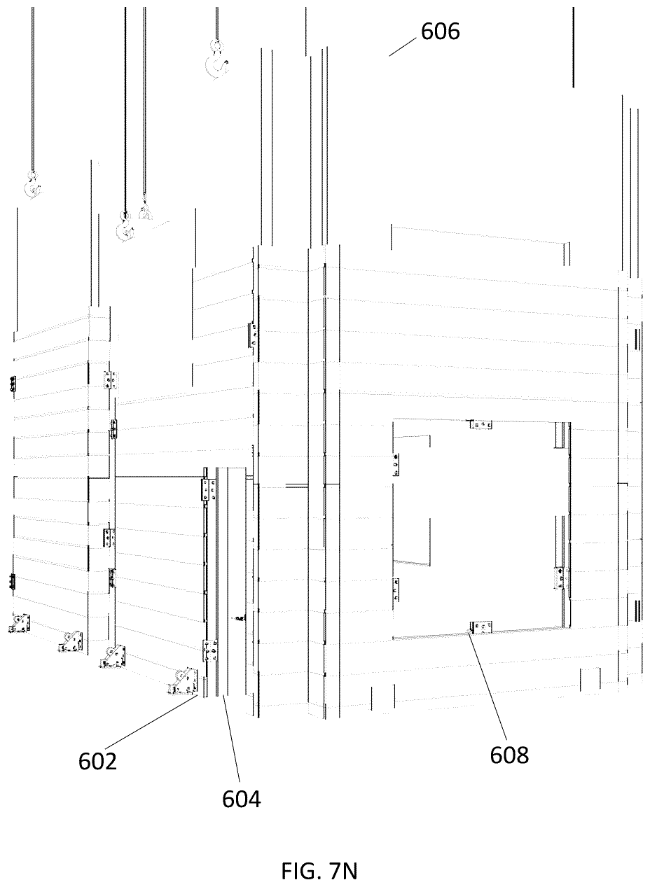

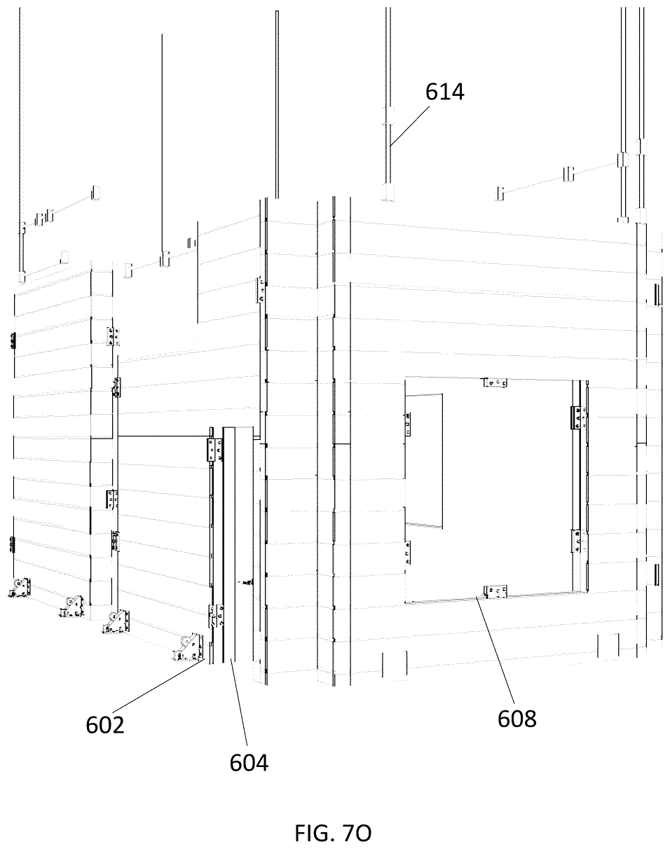

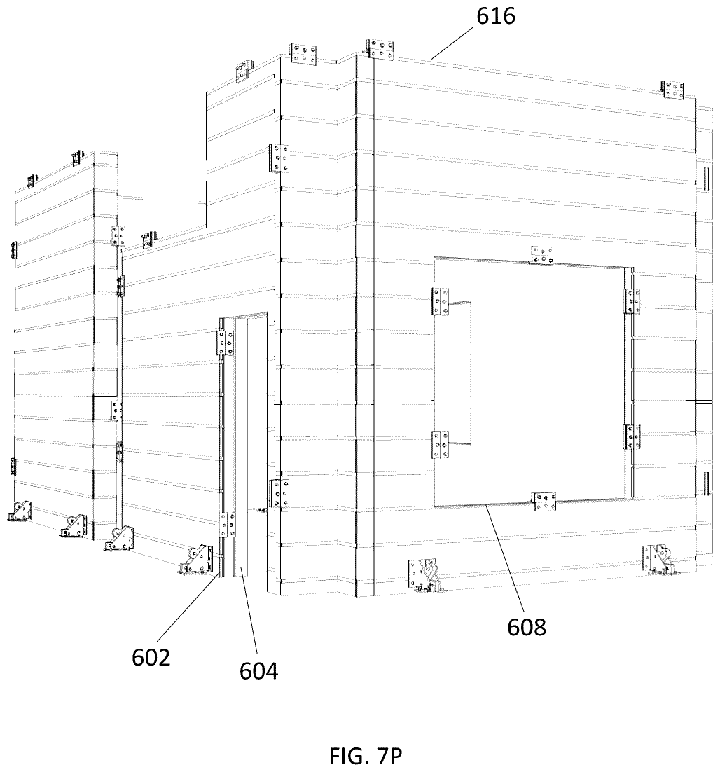

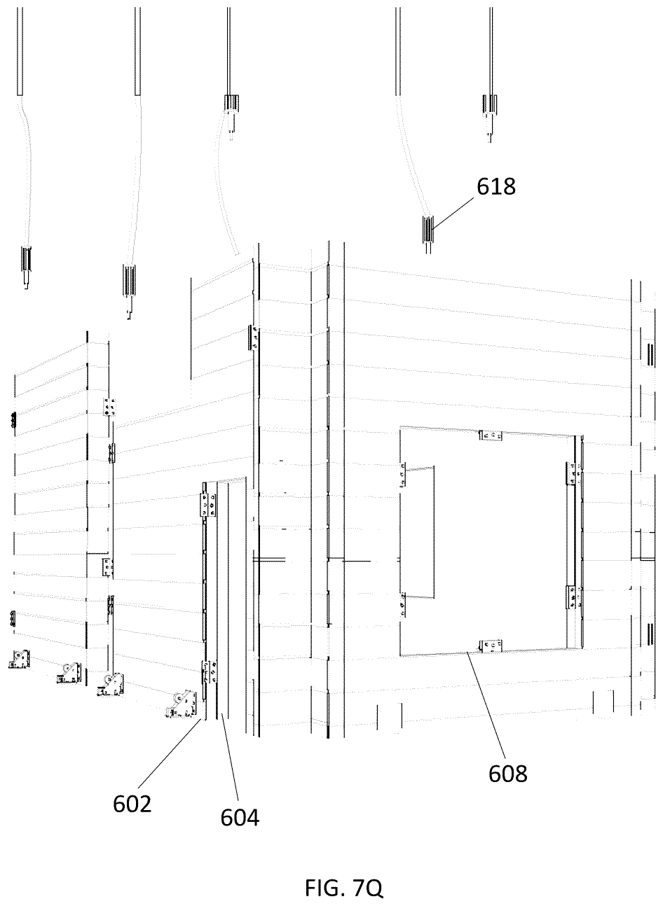

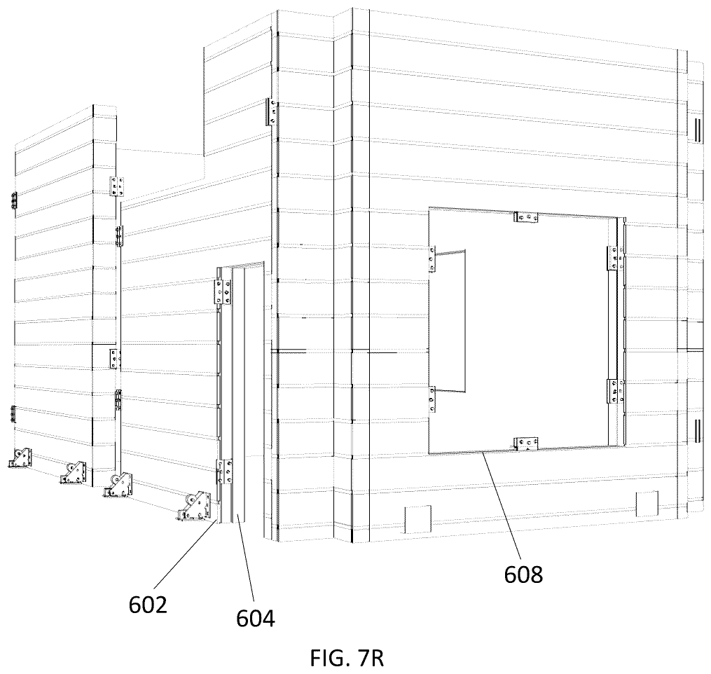

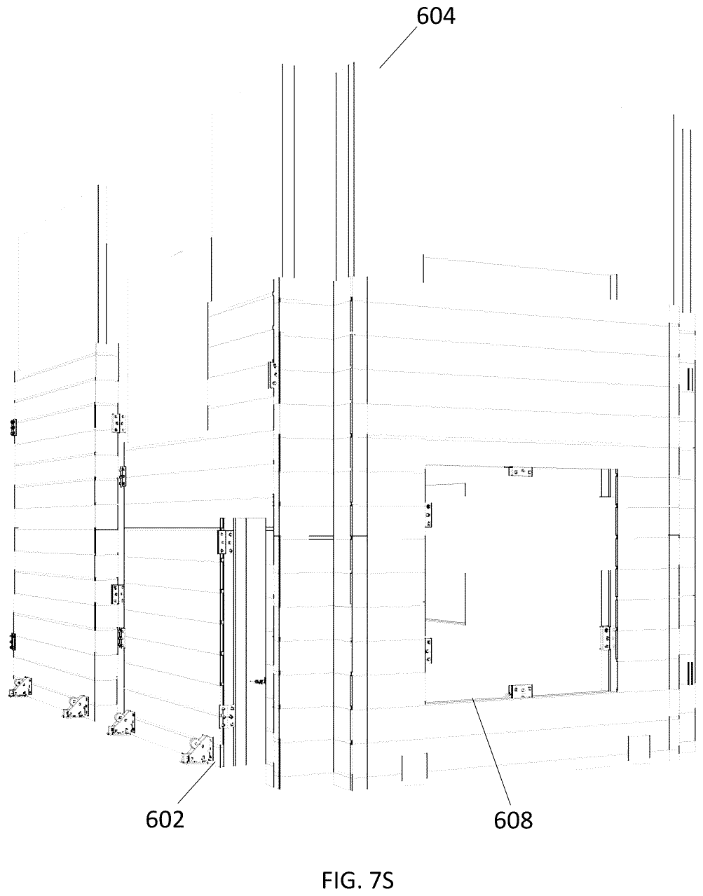

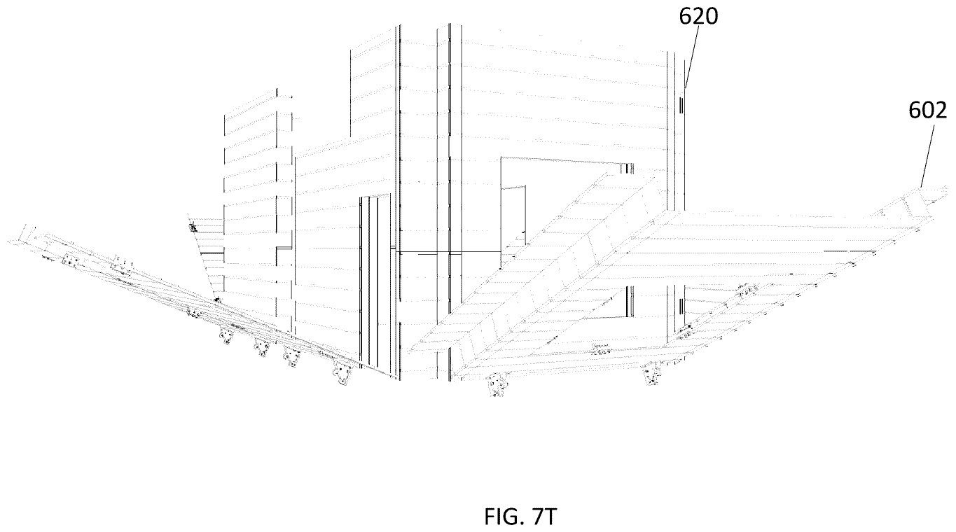

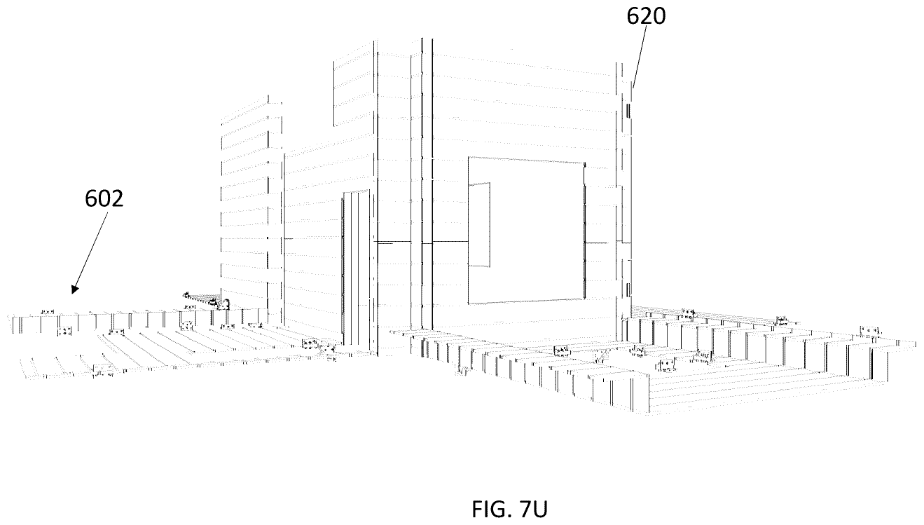

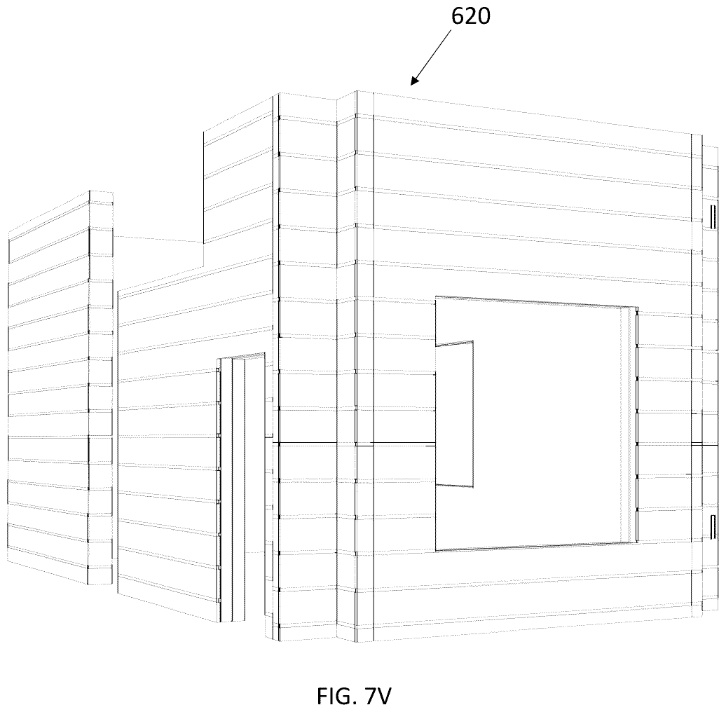

FIGS. 7A-V depict steps in a process for forming a wall section of a modular housing unit according to one embodiment of the present invention. One of ordinary skill in the art will understand that although the process depicted in FIGS. 7A-V shows the wall section being formed independently of the flooring, other embodiments with the wall and flooring sections integrally formed in a single process are contemplated herein. The process shown in FIGS. 7A-V allows for the generation of a wall section without the need for wood, nails, siding, drywall, paint, or the use of human hand manipulation, though one of ordinary skill in the art will understand that paint or other coatings are able to be later added. In one embodiment, no metal components are used in the wall panels or in any component of the structure. By not including metal components, the present invention avoids thermal bridging present in structures with metal through which heat escapes the structure or enters the structure.

The molding process beings with an exterior finish mold 602 laid out in an unfolded position, as shown in FIG. 7A. The exterior finish mold 602 is sized and shaped such that, when folded into an upright position, it substantially matches the geometry of the preformed wall section intended to be created. In one embodiment, the exterior finish mold 602 includes an interior surface pattern (e.g., horizontal or vertical lines) intended to be impressed on the exterior surface of the wall section. An interior finish mold 604 is then lowered within the exterior finish mold 602 (e.g., via cables or wires), as shown in FIGS. 7B and 7C. The interior finish mold 604 is shaped substantially the same as the exterior finish mold 602, but is slightly smaller, such that there is a substantially uniform gap between the interior finish mold 604 and the exterior finish mold 602. A cavity panel 606 is then lowered surrounding the interior finish mold 604 (e.g., via cables or wires), as shown in FIGS. 7D and 7E. The cavity panel 606 is similarly shaped substantially the same as both the interior finish mold 604 and the exterior finish mold 602, but is slightly scaled larger than the interior finish mold 604 and slightly scaled smaller than the exterior finish mold 602, meaning that it fits within the substantially uniform gap between the interior finish mold 604 and the exterior finish mold 602. However, the cavity panel 606 also leaves a thin interior gap between itself and the interior finish mold 604 and a thin exterior gap between itself and the exterior finish mold 602. Each of the interior finish mold 604, the exterior finish mold 602, and the cavity panel 606 are able to include gaps and holes 608 for windows and doors, just that these sections do not later need to be carved out of the molded wall section.

After the interior finish mold 604 and cavity mold are in place, the exterior finish mold 602 is folded upwardly to surround the cavity mold, thereby forming an outer shell, as shown in FIG. 7F, thereby created a layered molding system for the wall section, shown in FIG. 7G. A top plate 610, including holes for injection molding, is then lowered onto the molding system, as shown in FIGS. 7H and 7I. Fiber-reinforced plastic injection molding nozzles 612 are then lowered onto the top plate 610, and inject fiber-reinforced plastic (e.g., fiberglass-reinforced plastic) through the holes, as shown in FIGS. 7J and 7K. The fiber-reinforced plastic resin is then able to settle into the thin interior gap and thin exterior gap surrounding the cavity panel 606, forming an interior fiber-reinforced layer and an exterior fiber-reinforced layer.

The injection nozzles 612 are then removed and the molding system is left to sit for a period of time (e.g., four hours) while the resin bakes, cures and solidifies into form, as shown in FIG. 7L. The top plate 610 is then removed from the molding system, shown in FIG. 7M, and the cavity panel 606 is also then removed as well, shown in FIG. 7N. In one embodiment, the cavity panel 606 is removed by one or more lifting devices (e.g., hooks connected to portions of the cavity panel 606 configured to raise to lift the cavity panel out of the mold, cranes, etc.). A plurality of utility connection pipes 614 are then lowered into the gap between the interior fiber-reinforced layer and the exterior fiber-reinforced layer where the cavity panel 606 previously resided, as shown in FIG. 7O. A new top plate 616 is then added, to the top of the molding system, as shown in FIG. 7P. This new top plate 616 also includes openings for injection of insulation material, and insulation nozzles 618 are lowered to attach to these holes and inject insulation material between the interior fiber-reinforced layer and the exterior fiber-reinforced layer, as shown in FIG. 7Q. The insulation nozzles 618 are attached to one or more insulation reservoirs containing insulation, which are operable to be lowered with the insulation nozzles 618 or is operable to remain in place and attached to the insulation nozzles via one or more hoses. After the insulation has been injected, the new top plate 616 is removed, shown in FIG. 7R, and the interior finish mold 604 is then also removed, as shown in FIG. 7S. The exterior finish mold 602 is then unfolded, shown in FIGS. 7T and 7U, and a molded preformed wall section 620 for modular housing remains and is shown in FIG. 7V.

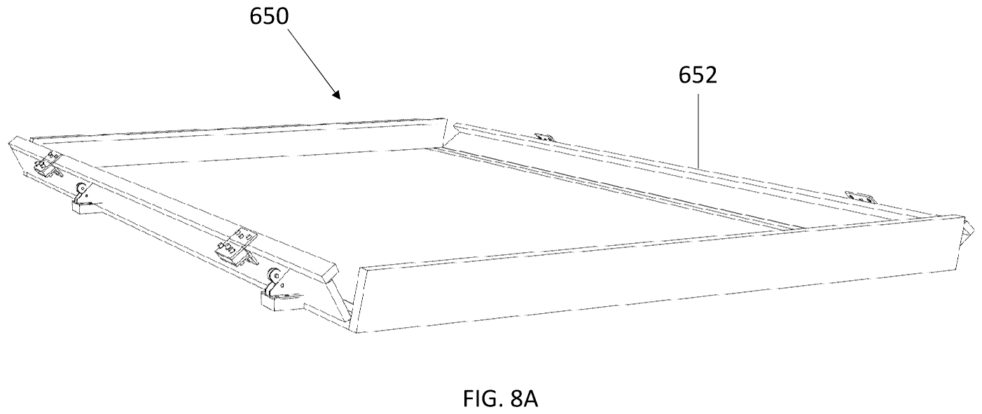

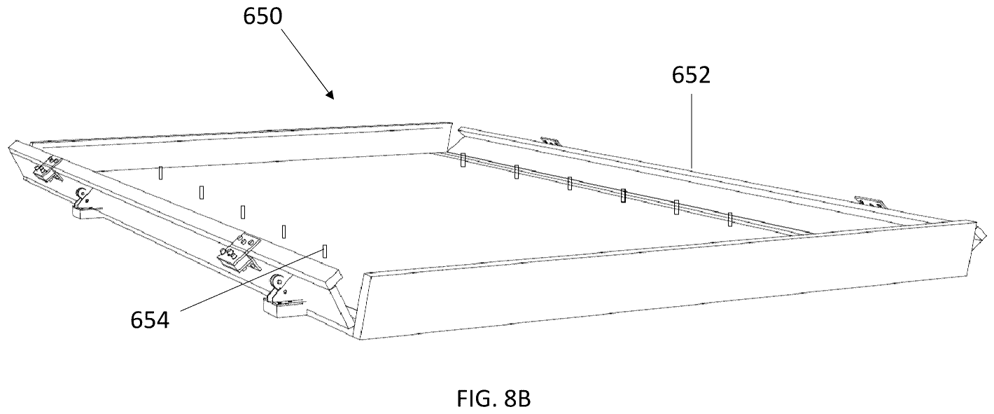

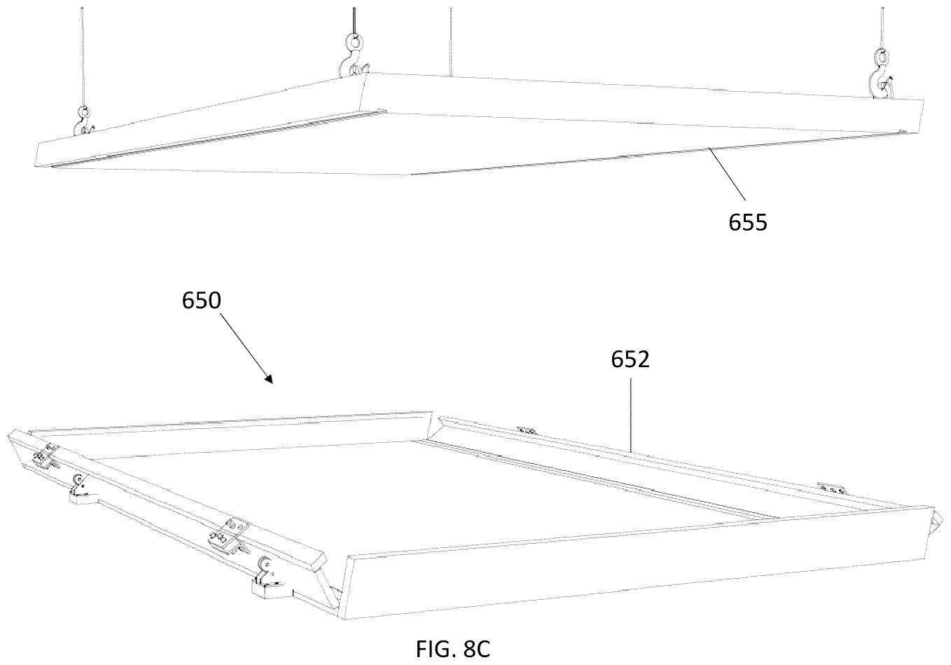

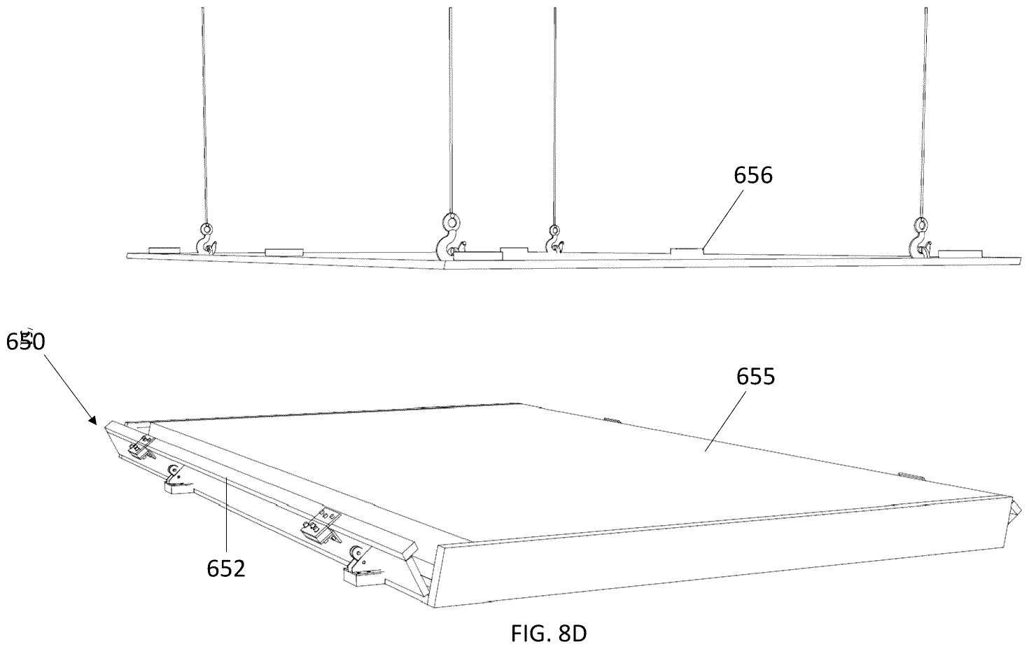

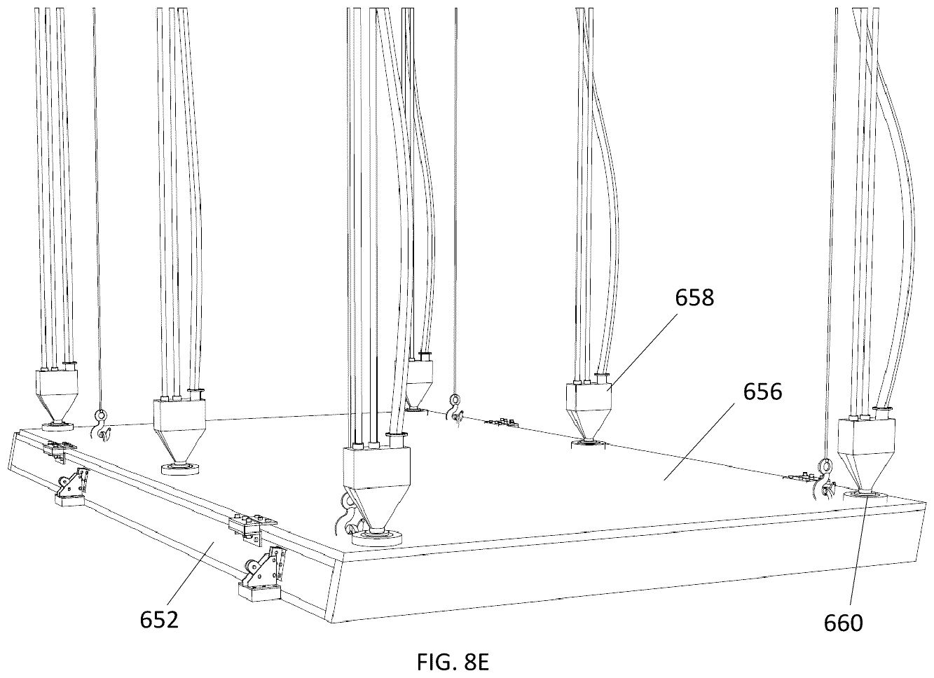

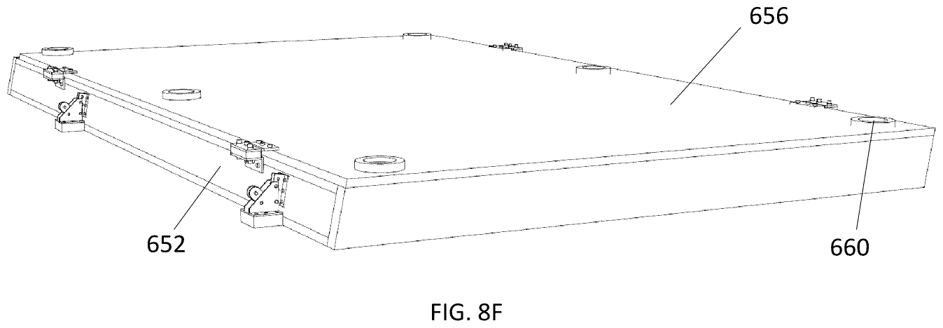

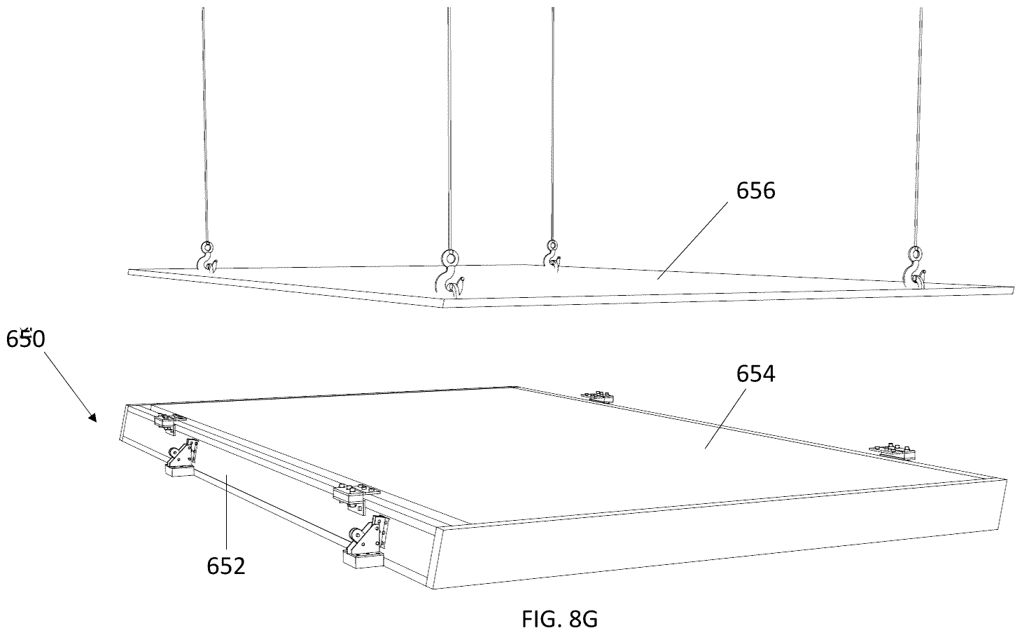

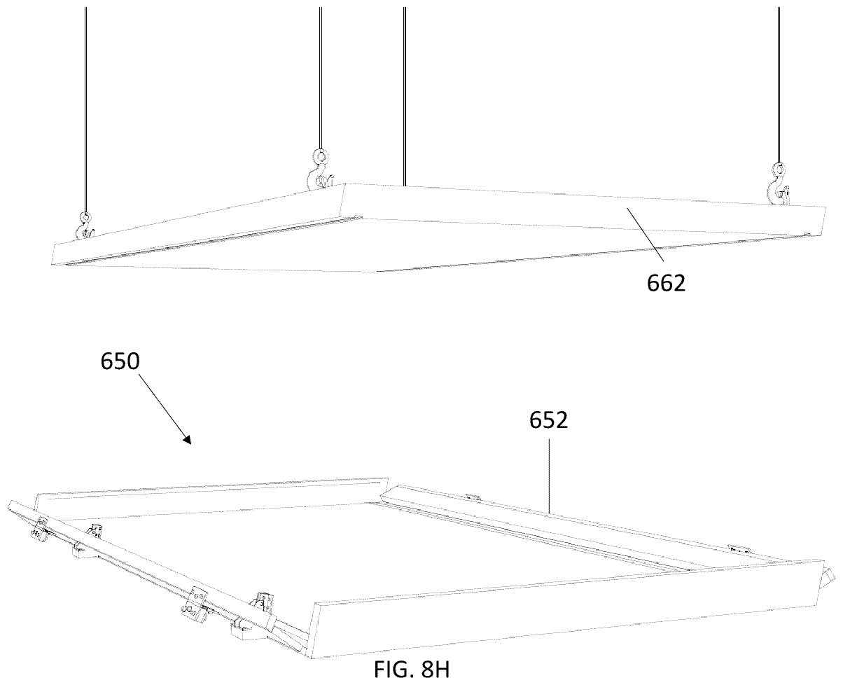

FIGS. 8A-H depict steps in a process for forming a roofing section of a modular housing unit according to one embodiment of the present invention. The process shown in FIGS. 8A-H allows for the generation of a roofing section without the need for wood, nails, siding, drywall, paint, or the use of human hand manipulation, though one of ordinary skill in the art will understand that paint or other coatings are able to be later added. In one embodiment, no metal components are used in roofing or in any component of the structure. By not including metal components, the present invention avoids thermal bridging present in structures with metal through which heat escapes the structure or enters the structure.

FIG. 8A illustrates a perspective view of a lower panel 650 for forming a roof section according to one embodiment of the present invention. The lower panel 650 includes side flaps 652 configured to fold upwardly, with the side flaps 652 including locking mechanisms for sealing the roofing molding system once fully constructed. In one embodiment, the lower panel 650 is formed from a metal material. In one embodiment, the lower panel 650 is surface roughened in order to provide the inner roof with a finish mimicking a dry wall (e.g., an orange peel finish). As shown in FIG. 8B, a plurality of locking pins 654 (for connecting to the wall section later) are able to be placed in specific places along the lower panel 650. A preformed insulation block 655 is placed downwardly onto the lower panel 650, as shown in FIG. 8C. Preferably, the preformed insulation block 655 includes a plurality of embedded utility conduits (e.g., electrical conduits, plumbing conduits, etc.). A top panel 656 is then placed over the preformed insulation block 655 to form a top of the roofing molding system, as shown in FIG. 8D. In one embodiment, the top panel 656 includes a patterned design in order to provide the molded roofing section with a more natural top appearance (e.g., a shingle finish pattern). In one embodiment, once the top panel 656 is added, the side flaps 652 are folded upwardly and locked with the top panel 656 in order to create a hermetically sealed interior chamber.

The top panel 656 includes a plurality of holes 660 to which one or more injection nozzles 658 are able to attach and inject fiber-reinforced plastic material, as shown in FIG. 8E. The fiber-reinforced plastic material flows around the preformed insulation block 655 such that the insulation block is contained within the finished product. The injection nozzles 658 are then removed and the resin is left to bake and cure for a period of time (e.g., approximately four hours), as shown in FIG. 8F. After this, the top panel 656 and ultimately subsequently the molded roofing section 662 are removed from the molding system, as shown in FIGS. 8G and 8H, respectively.

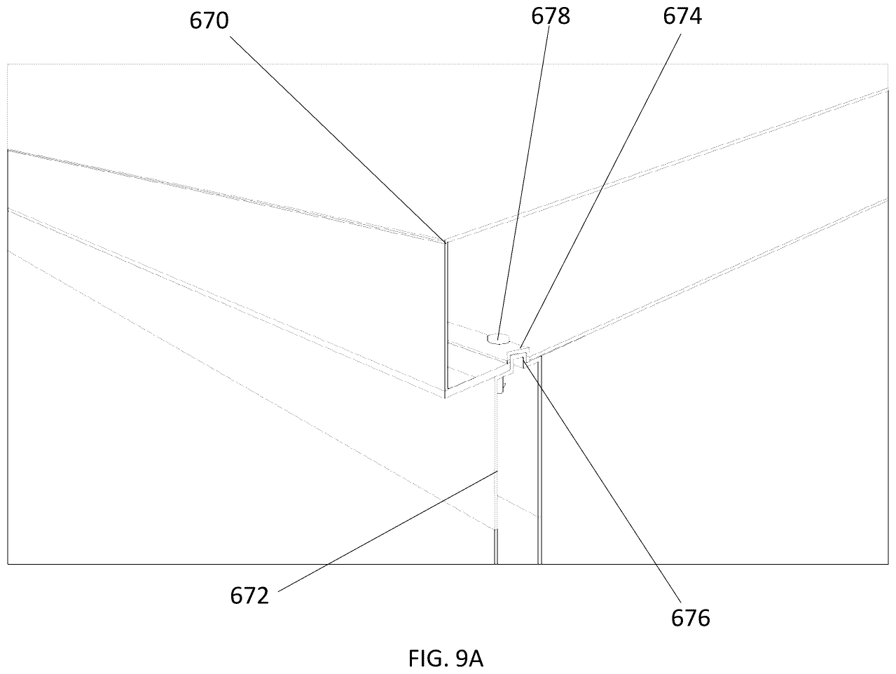

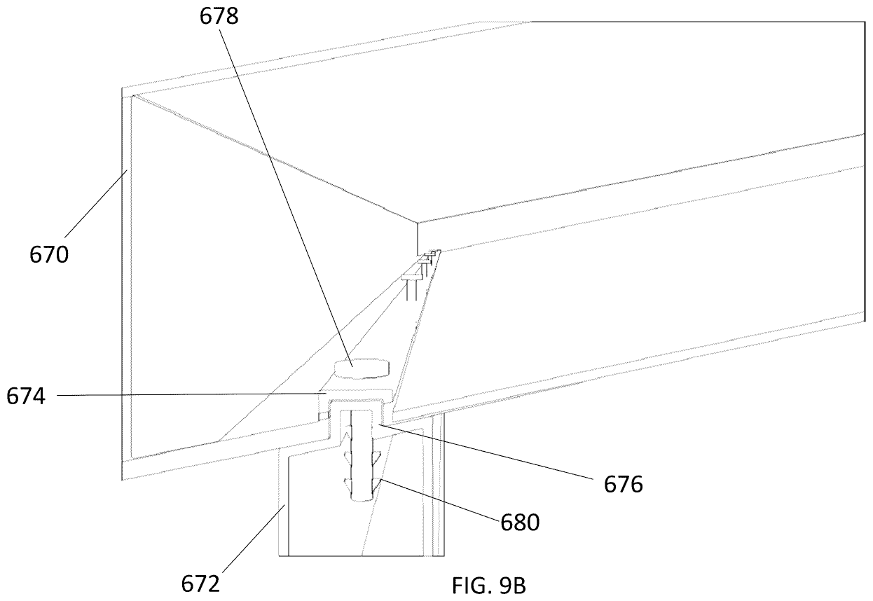

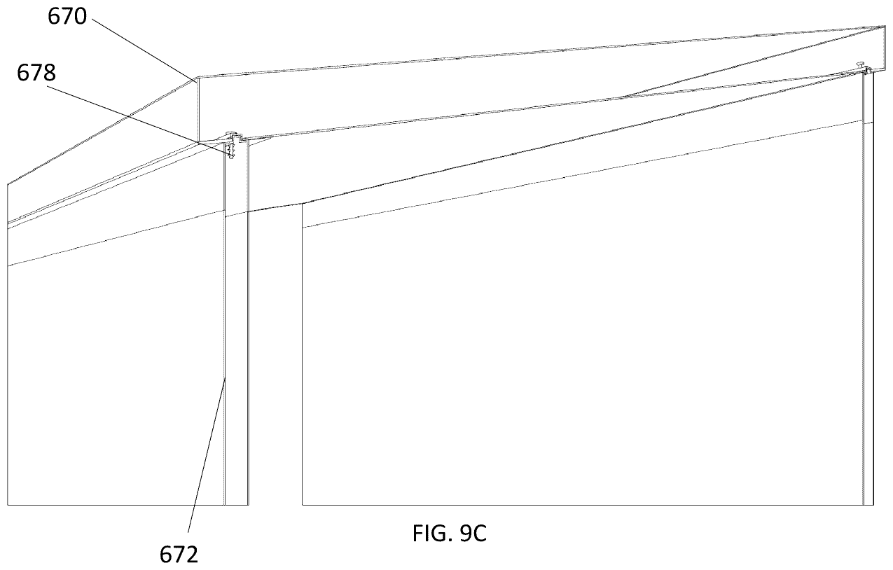

FIG. 9A illustrates an enlarged perspective view of an interconnection between a wall section 672 and a roof section 670 of the modular housing according to one embodiment of the present invention. As shown in FIGS. 9A and 9B, in one embodiment, the roofing section 670 does not include a short wall panel segment. Instead, in one embodiment, the roofing section 670 includes one or more grooves 674 into which ridges 676 at the top of the wall section 672 are configured to be matingly inserted. Locking pins 678 extend downwardly from the roofing section 670 through corresponding holes in the ridges 676 of the wall section 672 to lock the roofing section 670 and the wall section 672 together. In one embodiment, the locking pins 678 have prongs 680 such that, though they are able to deflect to enter the holes in the ridges 676 of the wall section 672, they are unable to withdraw from the holes. A wider perspective of the connection between the roofing section 670 and the wall section 672 is provided in FIG. 9C.

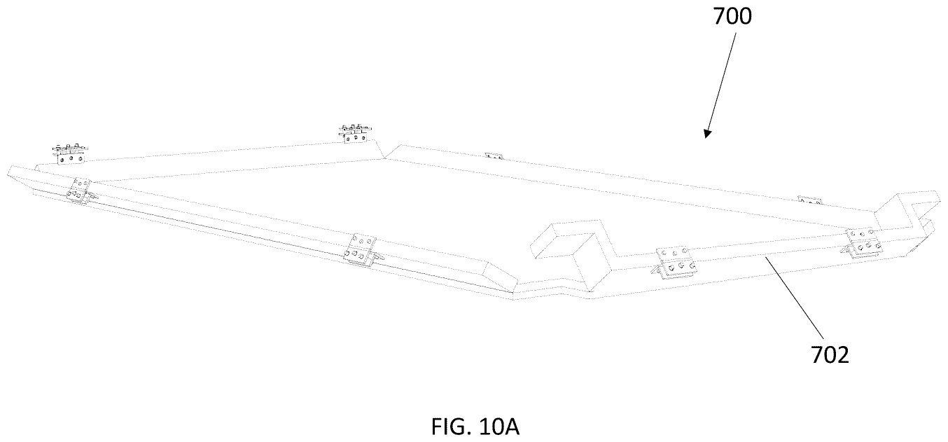

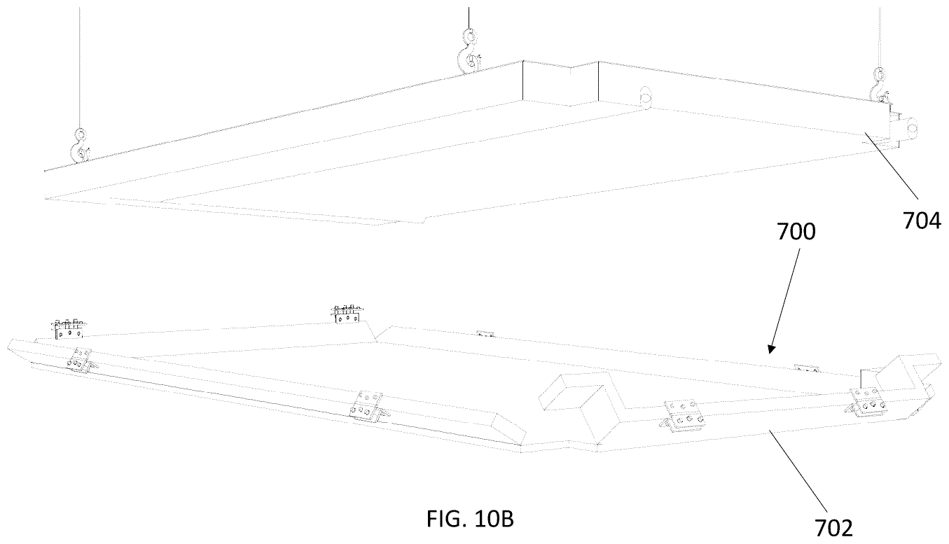

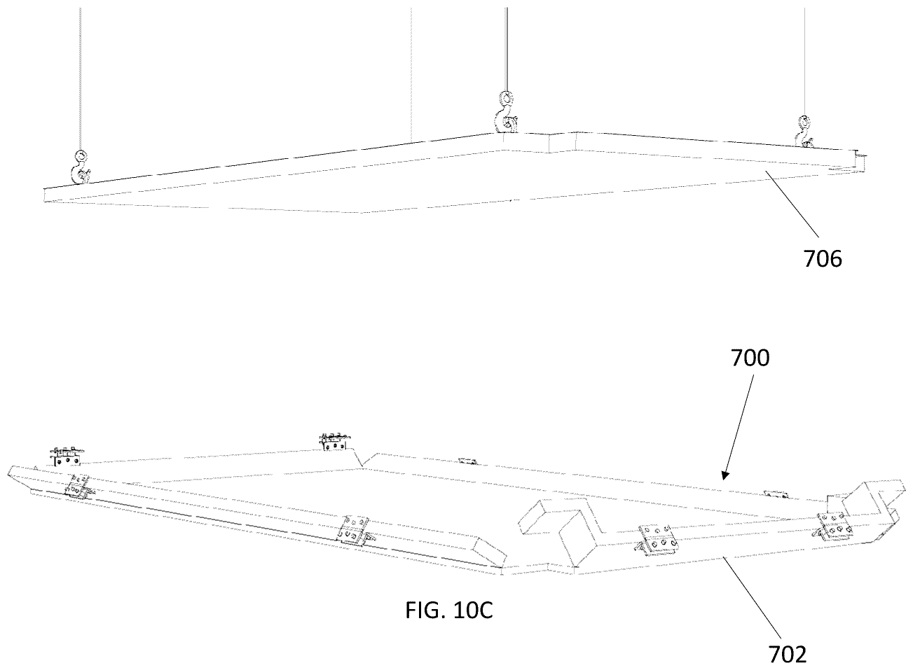

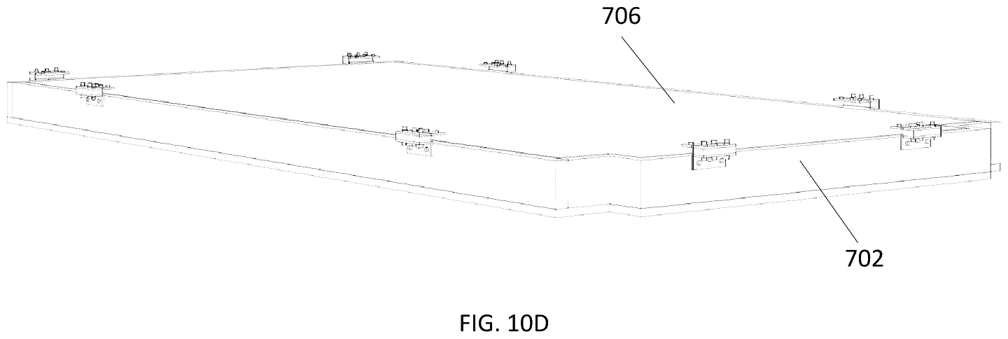

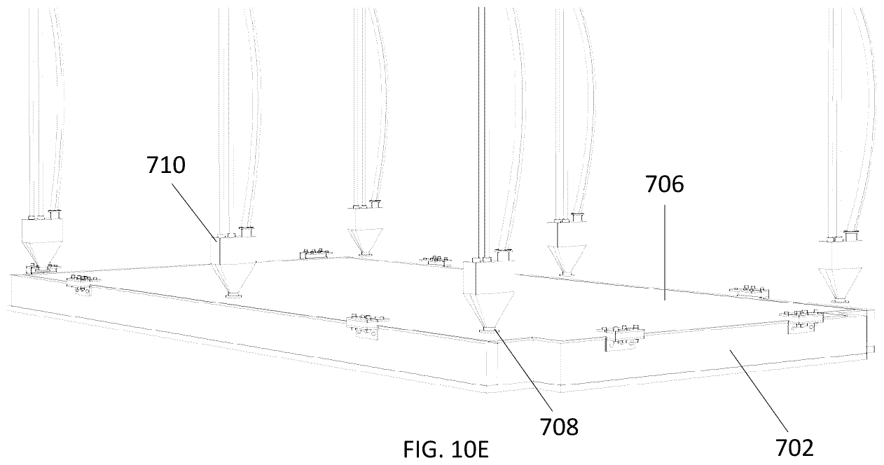

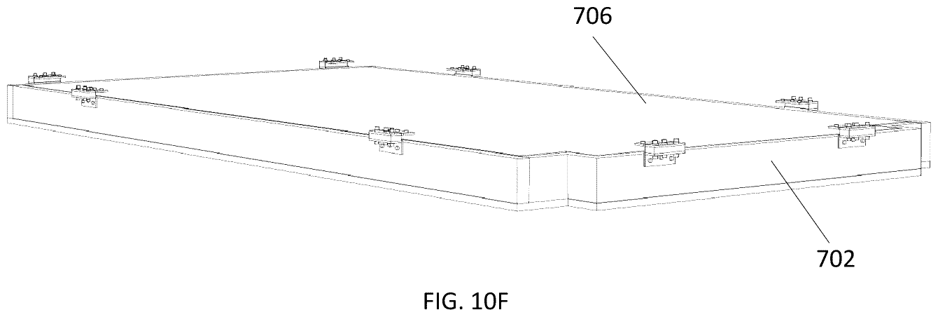

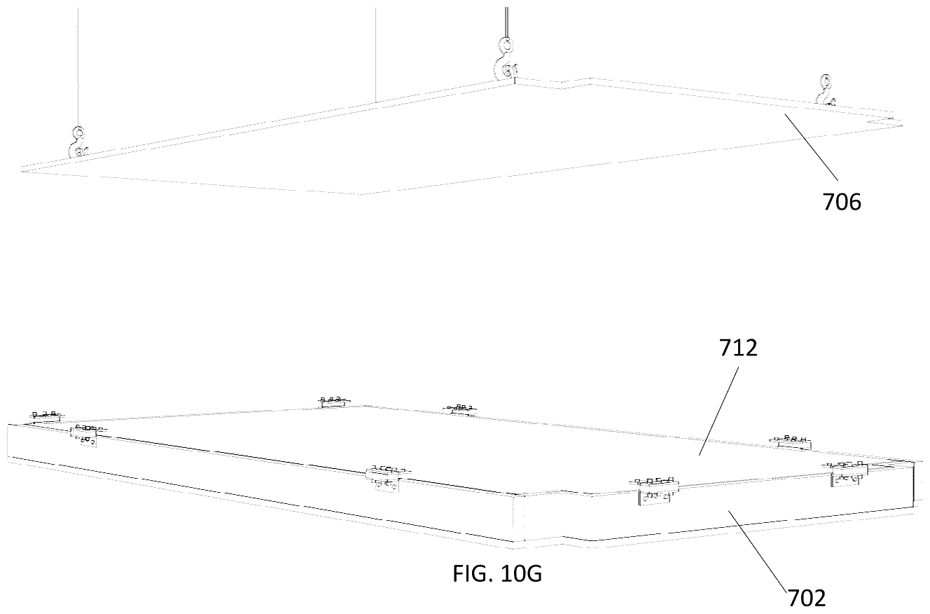

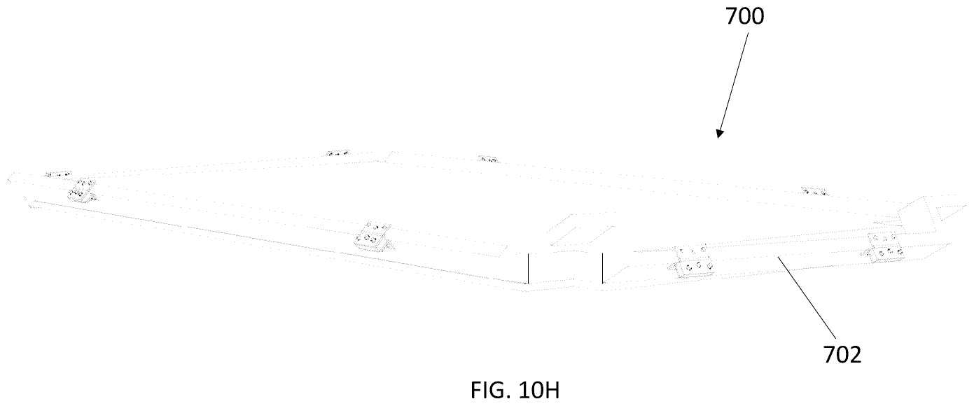

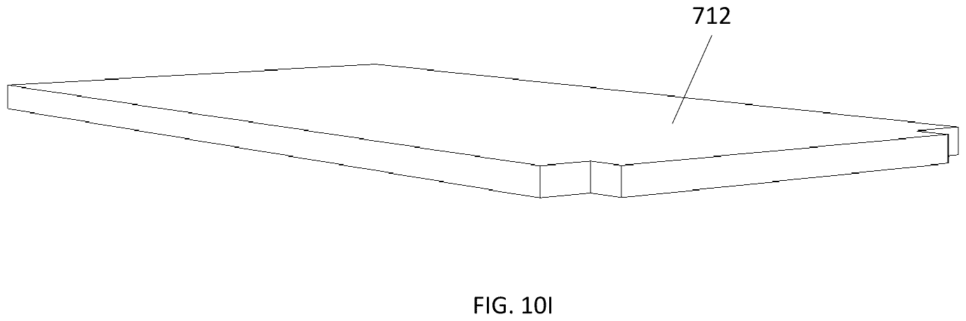

FIGS. 10A-I depict steps in a process for forming a flooring section of a modular housing unit according to one embodiment of the present invention. One of ordinary skill in the art will understand that although the process depicted in FIGS. 10A-I shows the flooring section being formed independently of the wall section, other embodiments with the wall and flooring sections integrally formed in a single process are contemplated herein. The process shown in FIGS. 10A-I allows for the generation of a flooring section without the need for wood, nails, siding, drywall, paint, or the use of human hand manipulation, though one of ordinary skill in the art will understand that paint or other coatings are able to be later added. In one embodiment, no metal components are used in the floor or in any component of the structure. By not including metal components, the present invention avoids thermal bridging present in structures with metal through which heat escapes the structure or enters the structure.

FIG. 10A illustrates a perspective view of a bottom slab panel 700 for forming a flooring section according to one embodiment of the present invention. The bottom slab panel 700 includes side flaps 702 configured to fold upwardly, with the side flaps 702 including locking mechanisms for sealing the flooring molding system once fully constructed. A preformed insulation block 704 is placed downwardly onto the bottom slab panel 700, as shown in FIG. 10B. Preferably, the preformed insulation block 704 includes a plurality of embedded utility conduits (e.g., electrical conduits, plumbing conduits, etc.). A top panel 706 is then placed over the preformed insulation block 704 to form a top of the flooring molding system, as shown in FIG. 10C. In one embodiment, the top panel 706 includes a patterned design in order to provide the molded flooring section with a more natural top appearance or texture. In one embodiment, once the top panel 706 is added, the side flaps 702 are folded upwardly and locked with the top panel 706 in order to create a hermetically sealed interior chamber, as shown in FIG. 10D.

The top panel 706 includes a plurality of holes 708 to which one or more injection nozzles 610 are able to attach and inject fiber-reinforced plastic material, as shown in FIG. 10E. The fiber-reinforced plastic material flows around the preformed insulation block 704 such that the insulation block 704 is contained within the finished product. The injection nozzles 610 are then removed and the resin is left to bake and cure for a period of time (e.g., approximately four hours), as shown in FIG. 10F. After this, the top panel 706 and the bottom slab panel 700 are removed from the molding system, as shown in FIGS. 10G and 10H, respectively, resulting in a molded flooring section 712 shown in FIG. 10I.

While the present invention has been primarily described as being manufactured using particular molding systems and methods, alternative methods for creating the components of the present invention are operable to be utilized, depending on the material and the size of the components. By way of example, and not limitation, open molding, closed molding, cast polymer molding, chop spray, hand layup, three-dimensional (3D) printing, twin-sheet thermoforming, rotational molding, compression molding utilizing tape, compression molding using bulk molding compound, gravity fed casting, compression molding utilizing sheet molding compound, squish molding, pultrusion, low pressure (LP) casting, high pressure (HP) casting, resin transfer (RT) molding, light RT molding, extrusion, Digital Light Synthesis (DLS), vacuum forming, infusion, vacuum infusion, flex molding, and/or lamination are operable to be used to form the components of the present invention.

Similarly, the components of the present invention are operable to be manufactured using any composite or polymer known in the art, including reinforced and unreinforced polymer materials, composites, thermosets, thermoplastics, fiberglass, and combinations thereof.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for constructing modular housing, comprising:
an outer molding panel;
an inner molding panel;
a cavity panel, wherein the cavity panel is placed between the outer molding panel and the inner molding panel with an inner gap defined between the cavity panel and the inner molding panel and an outer gap defined between the cavity panel and the outer molding panel;
a top plate, configured to sealingly enclose the outer molding panel, the inner molding panel, and the cavity panel;
one or more injection molding nozzles configured to connected to ports in the top plate, the inner molding panel, and/or the outer molding panel and inject resin into the inner gap and the outer gap to form an inner layer and an outer layer of a housing wall;
one or more lifting devices configured to remove the top plate and the cavity panel;
one or more insulation reservoirs and nozzles configured to release insulation material between the inner layer and the outer layer of the housing wall to form an inner insulation layer; and
a roof component including wall extensions extending downwardly, wherein the wall extensions are configured to align with the housing wall;
wherein the wall extensions of the roof component include a plurality of elongate extruded members extending downwardly, configured to insert into the inner insulation layer of the housing wall.

2. The system of claim 1, wherein the housing wall includes a plurality of locking pins configured to engage with and stabilize the plurality of elongate extruded members.

3. The system of claim 1, further comprising a floor component formed via injection molding between a top plate and a bottom plate.

4. The system of claim 1, further comprising a plurality of hollow conduits disposed in the inner gap and/or the outer gap, configured to receive one or more power supply cables.

5. The system of claim 1, wherein the resin includes a fiber-reinforced plastic resin.

6. The system of claim 1, wherein the housing wall is a single integrally formed component.

7. The system of claim 1, wherein a top of the housing wall includes at least one weatherstrip configured to compress between the housing wall and the wall extensions of the roof component to form a weather resistant barrier.

8. The system of claim 1, wherein the outer molding panel includes one or more bottom hinges configured to allow the outer molding panel to fold outwardly after the resin is injected.

9. A method for constructing modular housing, comprising:
placing an outer molding panel, an inner molding panel, and a cavity panel, such that the cavity panel is placed between the outer molding panel and the inner molding panel, an inner gap defined between the cavity panel and the inner molding panel, and an outer gap defined between the cavity panel and the outer molding panel;
sealingly enclosing the outer molding panel, the inner molding panel, and the cavity panel with a top plate;
one or more injection molding nozzles connecting to ports in the top plate, the inner molding panel, and/or the outer molding panel and injecting resin into the inner gap and the outer gap, thereby forming an inner layer and an outer layer of a housing wall;
one or more lifting devices removing the top plate and the cavity panel;
one or more insulation reservoirs having nozzles releasing insulation material between the inner layer and the outer layer of the housing wall to form an inner insulation layer; and
lowering a roof component including wall extensions extending downwardly, wherein the wall extensions are configured to align with the housing wall;
wherein the wall extensions of the roof component include a plurality of elongate extruded members extending downwardly and inserting into the inner insulation layer of the housing wall.

10. The method of claim 9, wherein the housing wall includes a plurality of locking pins configured to engage with and stabilize the plurality of elongate extruded members.

11. The method of claim 9, further comprising forming a floor component via injection molding between a top plate and a bottom plate.

12. The method of claim 9, further comprising a plurality of hollow conduits disposed in the inner gap and/or the outer gap, configured to receive one or more power supply cables.

13. The method of claim 9, wherein the resin includes a fiber-reinforced plastic resin.

14. The method of claim 9, wherein the housing wall is a single integrally formed component.

15. The method of claim 9, wherein a top of the housing wall includes at least one weatherstrip configured to compress between the housing wall and the wall extensions of the roof component to form a weather resistant barrier.

16. The method of claim 9, wherein the outer molding panel includes one or more bottom hinges configured to allow the outer molding panel to fold outwardly after the resin is injected.

17. A system for constructing modular housing, comprising:
an outer molding panel;
an inner molding panel;
a cavity panel, wherein the cavity panel is placed between the outer molding panel and the inner molding panel with an inner gap defined between the cavity panel and the inner molding panel and an outer gap defined between the cavity panel and the outer molding panel;
one or more injection molding nozzles configured to connected to ports in the top plate, the inner molding panel, and/or the outer molding panel and inject resin into the inner gap and the outer gap to form an inner layer and an outer layer of a housing wall;
one or more insulation reservoirs and nozzles configured to release insulation material between the inner layer and the outer layer of the housing wall to form an inner insulation layer after the cavity panel is removed; and
a roof component including wall extensions extending downwardly, wherein the wall extensions are configured to align with the housing wall;
wherein the wall extensions of the roof component include a plurality of elongate extruded members extending downwardly, configured to insert into the inner insulation layer of the housing wall; and
wherein the housing wall includes a plurality of locking pins configured to engage with and stabilize the plurality of elongate extruded members.

18. The system of claim 17, wherein the resin includes a fiber-reinforced plastic resin.

19. The system of claim 17, wherein a top of the housing wall includes at least one weatherstrip configured to compress between the housing wall and the wall extensions of the roof component to form a weather resistant barrier.

20. The system of claim 17, wherein the housing wall is a single integrally formed component.
